(19) United States
(12) Patent Application Publication
(10) Pub. No.: US 2025/0155258 A1
(43) Pub. Date: May 15, 2025

(54) INFORMATION PROCESSING DEVICE, INFORMATION PROCESSING METHOD, AND MOVING BODY

(71) Applicant: Sony Group Corporation, Tokyo (JP)

(72) Inventors: Hidehiro KOMATSU, Tokyo (JP); Tomohiro ARIKADO, Tokyo (JP); Shinichi IRIYA, Tokyo (JP); Masahiro TAMORI, Tokyo (JP); Daisuke KUBOTA, Tokyo (JP); Takuya SHOJI, Tokyo (JP); Yuji MORITA, Tokyo (JP); Hiroyuki UEYAMA, Tokyo (JP)

(73) Assignee: Sony Group Corporation, Tokyo (JP)

(21) Appl. No.: 18/840,085

(22) PCT Filed: Feb. 15, 2023
(86) PCT No.: PCT/JP2023/005123

§ 371 Date: Aug. 21, 2024

(30) Foreign Application Priority Data
Mar. 4, 2022 (JP) 2022-033776

(51) Int. Cl. G01C 21/36; G06T 11/00

(52) U.S. Cl. CPC G01C 21/365; G01C 21/3647; G06T 11/00

(57) ABSTRACT

The present technology relates to an information processing device, an information processing method, and a moving body for achieving appropriate driving assistance with use of visual information.

The information processing device includes an output control unit that superimposes visual information associated with driving assistance at least either within a visual field of a driver, or on a surrounding image indicating surroundings of a moving body and presented to the driver. The visual information is superimposed on the basis of at least any one of a sensing result around the moving body, information acquired from an outside, and information accumulated on the moving body. For example, the present technology is applicable to a vehicle.

### TECHNICAL FIELD

The present technology relates to an information processing device, an information processing method, and a moving body, and to an information processing device, an information processing method, and a moving body capable of assisting driving with use of visual information.

### BACKGROUND ART

It has been progressing in recent years to develop such a vehicle which presents visual information associated with driver assistance by using a head-up display (HUD) (e.g., see PTL 1).

### CITATION LIST

### Patent Literature

### [PTL 1]

PCT Patent Publication No. WO2018/168531

### SUMMARY

### Technical Problem

It is therefore predicted that a larger number of display devices will be mounted on each vehicle, or that a larger-sized display device such as a larger-sized head-up display will be equipped in the future. It is also demanded that use of visual information displayed on the display devices provided as above will contribute to appropriate driving assistance.

The present technology has been developed in consideration of the above-mentioned circumstances, and aims at offering appropriate driving assistance with use of visual information.

### Solution to Problem

An information processing device according to a first aspect of the present technology includes an output control unit that superimposes visual information associated with driving assistance at least either within a visual field of a driver, or on a surrounding image indicating surroundings of a moving body and presented to the driver, the visual information being superimposed on the basis of at least any one of a sensing result around the moving body, information acquired from an outside, and information accumulated on the moving body.

An information processing method according to a first aspect of the present technology includes superimposing visual information associated with driving assistance at least either within a visual field of a driver, or on a surrounding image indicating surroundings of a moving body and presented to the driver, the visual information being superimposed on the basis of at least any one of a sensing result around the moving body, information acquired from an outside, and information accumulated on the moving body.

According to the first aspect of the present technology, the visual information associated with driving assistance is superimposed at least either within the visual field of the driver or on the surrounding image indicating surroundings of the moving body and presented to the driver on the basis of at least any one of the sensing result around the moving body, the information acquired from the outside, and the information accumulated on the moving body.

A moving body according to a second aspect of the present technology includes a sensing unit that senses surroundings, a communication unit that communicates with an outside, and an output unit that superimposes visual information associated with driving assistance at least either within a visual field of a driver, or on a surrounding image presented to the driver, the visual information being superimposed on the basis of at least any one of a sensing result obtained by the sensing unit, information acquired from an outside, and information accumulated inside.

According to the second aspect of the present technology, surroundings are sensed, communications are exchanged with the outside, and the visual information associated with driving assistance is superimposed at least either within the visual field of the driver or on the surrounding image presented to the driver on the basis of at least any one of the sensing result, the information acquired from the outside, and the information accumulated inside.

### BRIEF DESCRIPTION OF DRAWINGS

FIG. 1 is a block diagram depicting a configuration example of a vehicle control system.

FIG. 2 is a diagram depicting an example of sensing regions.

FIG. 3 is a block diagram depicting a detailed configuration example of an HMI.

FIG. 4 is a diagram depicting a configuration example of a display constituting a display system of a vehicle.

FIG. 5 is a flowchart for explaining a parking assistance process.

FIG. 6 is a diagram for explaining a first display example of visual information during parking assistance.

FIG. 7 is a diagram for explaining the first display example of the visual information during parking assistance.

FIG. 8 is a diagram for explaining the first display example of the visual information during parking assistance.

FIG. 9 is a diagram for explaining the first display example of the visual information during parking assistance.

FIG. 10 is a diagram for explaining a second display example of the visual information during parking assistance.

FIG. 11 is a diagram for explaining the second display example of the visual information during parking assistance.

FIG. 12 is a diagram for explaining the second display example of the visual information during parking assistance.

FIG. 13 is a diagram for explaining the second display example of the visual information during parking assistance.

FIG. 14 is a diagram for explaining a third display example of the visual information during parking assistance.

FIG. 15 is a diagram for explaining the third display example of the visual information during parking assistance.

FIG. 16 is a diagram for explaining the third display example of the visual information during parking assistance.

FIG. 17 is a diagram for explaining the third display example of the visual information during parking assistance.

FIG. 18 is a diagram for explaining the third display example of the visual information during parking assistance.

FIG. 19 is a diagram for explaining a fourth display example of the visual information during parking assistance.

FIG. 20 is a diagram for explaining the fourth display example of the visual information during parking assistance.

FIG. 21 is a diagram for explaining the fourth display example of the visual information during parking assistance.

FIG. 22 is a diagram for explaining the fourth display example of the visual information during parking assistance.

FIG. 23 is a diagram for explaining the fourth display example of the visual information during parking assistance.

FIG. 24 is a diagram for explaining the fourth display example of the visual information during parking assistance.

FIG. 25 is a diagram for explaining a fifth display example of the visual information during parking assistance.

FIG. 26 is a diagram for explaining the fifth display example of the visual information during parking assistance.

FIG. 27 is a diagram for explaining the fifth display example of the visual information during parking assistance.

FIG. 28 is a diagram for explaining the fifth display example of the visual information during parking assistance.

FIG. 29 is a flowchart for explaining a left-turn assistance process.

FIG. 30 is a diagram for explaining the left-turn assistance process.

FIG. 31 is a diagram for explaining the left-turn assistance process.

FIG. 32 is a diagram for explaining the left-turn assistance process.

FIG. 33 is a diagram for explaining the left-turn assistance process.

FIG. 34 is a flowchart for explaining a tollgate passing assistance process.

FIG. 35 is a diagram for explaining the tollgate passing assistance process.

FIG. 36 is a diagram for explaining the tollgate passing assistance process.

FIG. 37 is a diagram for explaining the tollgate passing assistance process.

FIG. 38 is a flowchart for explaining a roundabout driving assistance process.

FIG. 39 is a diagram for explaining the roundabout driving assistance process.

FIG. 40 is a diagram for explaining the roundabout driving assistance process.

FIG. 41 is a diagram for explaining the roundabout driving assistance process.

FIG. 42 is a diagram for explaining the roundabout driving assistance process.

FIG. 43 is a diagram for explaining the roundabout driving assistance process.

FIG. 44 is a diagram for explaining the roundabout driving assistance process.

FIG. 45 is a diagram for explaining the roundabout driving assistance process.

FIG. 46 is a diagram for explaining the roundabout driving assistance process.

FIG. 47 is a diagram for explaining the roundabout driving assistance process.

FIG. 48 is a diagram for explaining the roundabout driving assistance process.

FIG. 49 is a diagram for explaining the roundabout driving assistance process.

FIG. 50 is a diagram for explaining the roundabout driving assistance process.

FIG. 51 is a diagram for explaining the roundabout driving assistance process.

FIG. 52 is a diagram for explaining the roundabout driving assistance process.

FIG. 53 is a diagram for explaining the roundabout driving assistance process.

FIG. 54 is a diagram for explaining the roundabout driving assistance process.

FIG. 55 is a diagram for explaining the roundabout driving assistance process.

FIG. 56 is a diagram for explaining the roundabout driving assistance process.

FIG. 57 is a diagram for explaining the roundabout driving assistance process.

FIG. 58 is a diagram for explaining the roundabout driving assistance process.

FIG. 59 is a diagram for explaining the roundabout driving assistance process.

FIG. 60 is a block diagram depicting a configuration example of a computer.

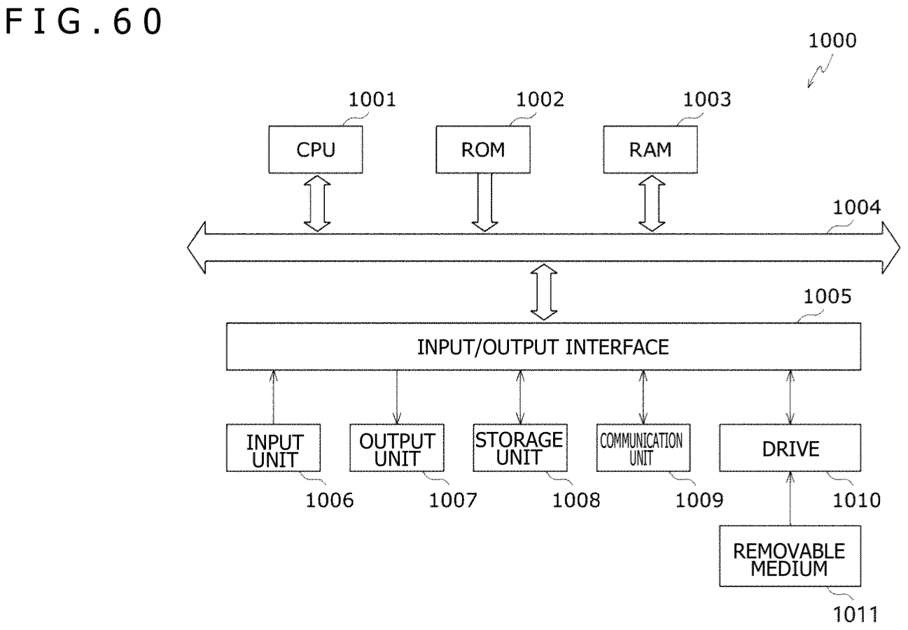

### DESCRIPTION OF EMBODIMENT

A mode for practicing the present technology will be hereinafter described. The description will be presented in a following order.
1. Configuration example of vehicle control system
2. Embodiment
3. Modifications
4. Others

### 1. Configuration Example of Vehicle Control System

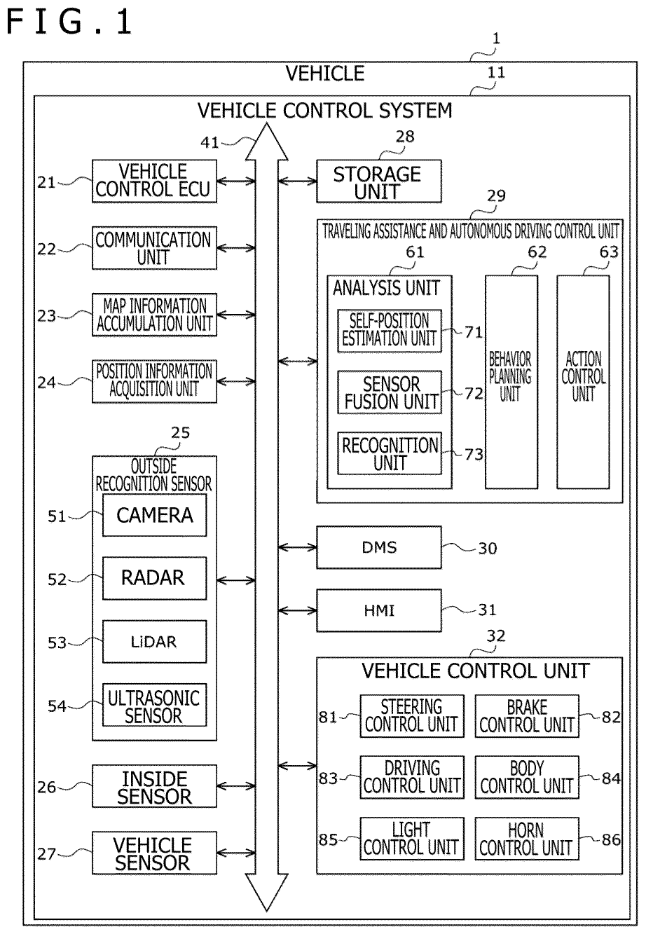

FIG. 1 is a block diagram depicting a configuration example of a vehicle control system 11 which is an example of a moving device control system to which the present technology is applied.

The vehicle control system 11 is provided on a vehicle 1 to perform processes associated with traveling assistance and autonomous driving of the vehicle 1.

The vehicle control system 11 includes a vehicle control ECU (Electronic Control Unit) 21, a communication unit 22, a map information accumulation unit 23, a position information acquisition unit 24, an outside recognition sensor 25, an inside sensor 26, a vehicle sensor 27, a storage unit 28, a traveling assistance and autonomous driving control unit 29, a DMS (Driver Monitoring System) 30, an HMI (Human Machine Interface) 31, and a vehicle control unit 32.

The vehicle control ECU 21, the communication unit 22, the map information accumulation unit 23, the position information acquisition unit 24, the outside recognition sensor 25, the inside sensor 26, the vehicle sensor 27, the storage unit 28, the traveling assistance and autonomous driving control unit 29, the driver monitoring system (DMS) 30, the human machine interface (HMI) 31, and the vehicle control unit 32 are connected to each other via a communication network 41 to exchange communications with each other. For example, the communication network 41 includes an in-vehicle communication network, a bus, and the like operating in conformity with digital bidirectional communication standards, such as a CAN (Controller Area Network), a LIN (Local Interconnect Network), a LAN (Local Area Network), FlexRay (registered trademark), and Ethernet (registered trademark). The communication network 41 may be selected according to types of data to be transferred. For example, a CAN may be applied to data associated with vehicle control, while Ethernet may be applied to a large volume of data. Note that the respective components of the vehicle control system 11 in some cases are connected to each other not via the communication network 41 but directly with use of wireless communication assuming relatively short-distance communication, such as near field communication (NFC (Near Field Communication)) and Bluetooth (registered trademark).

Note that the communication network 41 will not be particularly mentioned hereinafter even in the case of communication between the respective components of the vehicle control system 11 via the communication network 41. For example, in the case of communication between the vehicle control ECU 21 and the communication unit 22 via the communication network 41, this communication will be simply expressed as communication between the vehicle control ECU 21 and the communication unit 22.

For example, the vehicle control ECU 21 includes various types of processors, such as a CPU (Central Processing Unit) and an MPU (Micro Processing Unit). The vehicle control ECU 21 controls entire or a part of functions of the vehicle control system 11.

The communication unit 22 communicates with various devices inside and outside the vehicle, other vehicles, servers, base stations, and the like to transmit and receive various data to and from these. At this time, the communication unit 22 is capable of exchanging communications by using a plurality of communication systems.

An outline of communication executable by the communication unit 22 to communicate with the outside of the vehicle will be explained. For example, the communication unit 22 communicates with a server existing on an external network (hereinafter referred to as an external server) and the like via a base station or an access point by using a wireless communication system such as 5G (fifth-generation mobile communication system), LTE (Long Term Evolution), and DSRC (Dedicated Short Range Communications). For example, the external network adopted for communication with the communication unit 22 is the Internet, a cloud network, a provider-specific network, or the like. The communication system performed by the communication unit 22 for communication with the external network may be any wireless communication system as long as digital bidirectional communication is achievable at a predetermined communication speed or higher and at a predetermined distance or longer.

Moreover, for example, the communication unit 22 is capable of communicating with a terminal existing near the own vehicle by using a P2P (Peer To Peer) technology. For example, the terminal existing near the own vehicle is a terminal attached to a moving body which is moving at a relatively low speed, such as a pedestrian and a bicycle, a terminal provided at a fixed position of a store or the like, or an MTC (Machine Type Communication) terminal. Furthermore, the communication unit 22 is capable of exchanging V2X communications. For example, the V2X communications refer to communications between the own vehicle and others, such as vehicle to vehicle communications (Vehicle to Vehicle) with other vehicles, vehicle to infrastructure communications (Vehicle to Infrastructure) with roadside units or the like, communications with home (Vehicle to Home), and vehicle to pedestrian communications (Vehicle to Pedestrian) with terminals or the like carried by pedestrians.

For example, the communication unit 22 is capable of receiving, from the outside, a program for updating software which controls operations of the vehicle control system 11 (Over The Air). The communication unit 22 is further capable of receiving map information, traffic information, information associated with surroundings of the vehicle 1, and others from the outside. Moreover, for example, the communication unit 22 is capable of transmitting information associated with the vehicle 1, information associated with surroundings of the vehicle 1, and others to the outside. For example, the information associated with the vehicle 1 and transmitted from the communication unit 22 to the outside includes data indicating a state of the vehicle 1, recognition results obtained by a recognition unit 73, and the like. Furthermore, for example, the communication unit 22 exchanges communications for handling a vehicle emergency report system, such as an e-call.

For example, the communication unit 22 receives electromagnetic waves transmitted from Vehicle Information and Communication System (VICS) (registered trademark) via radio beacons, optical beacons, FM multiple broadcasting, or the like.

An outline of communication executable by the communication unit 22 to communicate with the inside of the vehicle will be explained. For example, the communication unit 22 is capable of communicating with respective devices inside the vehicle by wireless communication. For example, the communication unit 22 is capable of wirelessly communicating with the devices inside the vehicle by using a communication system enabling digital bidirectional communication at a predetermined communication speed or higher via wireless communication, such as a wireless LAN, Bluetooth, NFC, and a WUSB (Wireless USB). Alternatively, the communication unit 22 may communicate with the respective devices inside the vehicle by wired communication. For example, the communication unit 22 is capable of communicating with the respective devices inside the vehicle by wired communication via a cable connected to a not-depicted connection terminal. For example, the communication unit 22 is capable of communicating with the respective devices inside the vehicle by using a communication system enabling digital bidirectional communication at a predetermined communication speed or higher via wired communication, such as a USB (Universal Serial Bus), HDMI (High-Definition Multimedia Interface) (registered trademark), and MHL (Mobile High-definition Link).

For example, the devices inside the vehicle herein refer to devices provided inside the vehicle and not connected to the communication network 41. Possible examples of the devices inside the vehicle include a mobile device or a wearable device carried by a vehicle occupant such as a driver, an information device carried into the vehicle and temporarily installed in the vehicle, and the like.

The map information accumulation unit 23 accumulates either one or both of a map acquired from the outside and a map created by the vehicle 1. For example, the map information accumulation unit 23 accumulates a three-dimensional high-definition map, a global map less accurate than the high-definition map and covering a wide area, or the like.

For example, the high-definition map is a dynamic map, a point cloud map, a vector map, or the like. For example, the dynamic map is a map having four layers of dynamic information, semi-dynamic information, semi-static information, and static information, and is supplied to the vehicle 1 from an external server or the like. The point cloud map is a map including point clouds (point cloud data). The vector map is a map which associates traffic information and the like, such as positions of lanes and traffic lights, with the point cloud map to fit the map to ADAS (Advanced Driver Assistance System) and AD (Autonomous Driving).

For example, the point cloud map and the vector map may be provided from an external server or the like, or may be created by the vehicle 1 as a map for matching with a local map described below on the basis of sensing results obtained by a camera 51, a radar 52, a LiDAR 53, or the like, and accumulated in the map information accumulation unit 23. In addition, in a case where a high-definition map is provided from an external server or the like, map data covering a several hundred meters square, for example, and associated with a planned path along which the vehicle 1 is to travel from now is acquired from the external server or the like so as to reduce a communication volume.

The position information acquisition unit 24 receives GNSS (Global Navigation Satellite System) signals from a GNSS satellite to acquire position information associated with the vehicle 1. The acquired position information is supplied to the traveling assistance and autonomous driving control unit 29. Note that the method adopted by the position information acquisition unit 24 to acquire the position information is not limited to the system using GNSS signals, but may a method using beacons, for example.

The outside recognition sensor 25 includes various types of sensors used for recognizing situations outside the vehicle 1, and supplies sensor data obtained from the respective sensors to the respective components of the vehicle control system 11. The types and the number of the sensors included in the outside recognition sensor 25 may be any types and number.

For example, the outside recognition sensor 25 includes the camera 51, the radar 52, the LiDAR (Light Detection and Ranging, Laser Imaging Detection and Raging) 53, and an ultrasonic sensor 54. Alternatively, the outside recognition sensor 25 may have a configuration including one or more types of sensors selected from the camera 51, the radar 52, the LiDAR 53, and the ultrasonic sensor 54. The number of units provided for each of the camera 51, the radar 52, the LIDAR 53, and the ultrasonic sensor 54 is not particularly limited, but may be any number practically providable on the vehicle 1. Moreover, the types of sensors included in the outside recognition sensor 25 are not limited to the examples presented above but may be other types of sensors. Examples of sensing regions of the respective sensors included in the outside recognition sensor 25 will be described below.

Note that an imaging system of the camera 51 is not particularly limited. For example, cameras using various types of imaging systems enabled to measure distances, such as a ToF (Time Of Flight) camera, a stereo camera, a monocular camera, and an infrared camera, may be applied to the camera 51 as necessary. Alternatively, the camera 51 may be a camera provided for only capturing images rather than for distance measurement.

Moreover, for example, the outside recognition sensor 25 may have an environment sensor for detecting an environment around the vehicle 1. The environment sensor is a sensor for detecting an environment such as weather, meteorology, and brightness, and may include various types of sensors such as a raindrop sensor, a fog sensor, a sunlight sensor, a snow sensor, and a luminance sensor.

Furthermore, for example, the outside recognition sensor 25 includes a microphone for detecting sound around the vehicle 1, a position of a sound source, and the like.

The inside sensor 26 includes various types of sensors for detecting information inside the vehicle, and supplies sensor data obtained from the respective sensors to the respective components of the vehicle control system 11. The types and the number of various sensors included in the inside sensor 26 are not particularly limited but may be any types and number practically providable on the vehicle 1.

For example, the inside sensor 26 may include one or more types of sensors selected from a camera, a radar, a seat sensor, a steering wheel sensor, a microphone, and a biosensor. For example, cameras using various types of imaging systems enabled to measure distances, such as a ToF camera, a stereo camera, a monocular camera, and an infrared camera, are adoptable as a camera included in the inside sensor 26. Alternatively, the camera included in the inside sensor 26 may be a camera for simply capturing images rather than for distance measurement. For example, the biosensor included in the inside sensor 26 is provided on a seat, a steering wheel, or the like to detect various types of biological information associated with the driver or other occupants.

The vehicle sensor 27 includes various types of sensors for detecting a state of the vehicle 1, and supplies sensor data obtained from the respective sensors to the respective components of the vehicle control system 11. The types and the number of various sensors included in the vehicle sensor 27 are not particularly limited but may be any types and number practically providable on the vehicle 1.

For example, the vehicle sensor 27 includes a speed sensor, an acceleration sensor, an angular speed sensor (gyro sensor), and an inertial measurement unit (IMU) unifying these sensors. For example, the vehicle sensor 27 includes a steering angle sensor for detecting a steering angle of the steering wheel, a yaw rate sensor, an accelerator sensor for detecting a manipulated amount of an accelerator pedal, and a brake sensor for detecting a manipulated amount of a brake pedal. For example, the vehicle sensor 27 includes a rotation sensor for detecting rotational speeds of an engine and a motor, an air pressure sensor for detecting an air pressure of tires, a slip ratio sensor for detecting slip ratios of tires, and a wheel speed sensor for detecting rotational speeds of wheels. For example, the vehicle sensor 27 includes a battery sensor for detecting a residual quantity and a temperature of a battery, and a shock sensor for detecting a shock received from the outside.

The storage unit 28 includes at least either a non-volatile storage medium or a volatile storage medium to store data and programs. For example, the storage unit 28 is used as an EEPROM (Electrically Erasable Programmable Read Only Memory) and a RAM (Random Access Memory). A magnetic storage device such as an HDD (Hard Disc Drive), a semiconductor storage device, an optical storage device, and a magneto-optical storage device are applicable to the storage medium. The storage unit 28 stores various types of programs and data used by the respective units of the vehicle control system 11. For example, the storage unit 28 includes an EDR (Event Data Recorder) and a DSSAD (Data Storage System for Automated Driving), and stores information associated with the vehicle 1 before and after an event such as an accident, and information acquired by the inside sensor 26.

The traveling assistance and autonomous driving control unit 29 assists traveling and controls autonomous driving of the vehicle 1. For example, the traveling assistance and autonomous driving control unit 29 includes an analysis unit 61, a behavior planning unit 62, and an action control unit 63.

The analysis unit 61 performs an analysis process for analyzing situations of the vehicle 1 and surroundings. The analysis unit 61 includes a self-position estimation unit 71, a sensor fusion unit 72, and a recognition unit 73.

The self-position estimation unit 71 estimates a self-position of the vehicle 1 on the basis of sensor data received from the outside recognition sensor 25, and a high-definition map accumulated in the map information accumulation unit 23. For example, the self-position estimation unit 71 creates a local map on the basis of the sensor data received from the outside recognition sensor 25, and matches the local map with the high-definition map to estimate the self-position of the vehicle 1. For example, the center of axles of a pair of rear wheels is designated as a reference for the position of the vehicle 1.

For example, the local map is a three-dimensional high-definition map, an occupancy grid map (Occupancy Grid Map), or the like created using a technology such as SLAM (Simultaneous Localization and Mapping). For example, the three-dimensional high-definition map is a point cloud map or the like described above. The occupancy grid map is a map which divides a three-dimensional or two-dimensional space around the vehicle 1 by a grid having a predetermined size, and indicates an occupancy state of an object in units of the grid. For example, the occupancy state of the object is expressed by the presence or absence or an existence probability of the object. For example, the local map is also available for processes performed by the recognition unit 73 for detecting and recognizing situations outside the vehicle 1.

Note that the self-position estimation unit 71 may estimate the self-position of the vehicle 1 on the basis of position information acquired by the position information acquisition unit 24, and sensor data received from the vehicle sensor 27.

The sensor fusion unit 72 performs a sensor fusion process for combining a plurality of different types of sensor data (e.g., image data supplied from the camera 51, and sensor data supplied from the radar 52) to obtain new information. The different types of sensor data are combined by methods such as integration, fusion, and unification.

The recognition unit 73 executes a detection process for detecting situations outside the vehicle 1, and a recognition process for recognizing situations outside the vehicle 1.

For example, the recognition unit 73 performs the detection process and the recognition process concerning situations outside the vehicle 1 on the basis of information received from the outside recognition sensor 25, information received from the self-position estimation unit 71, information received from the sensor fusion unit 72, and the like.

Specifically, for example, the recognition unit 73 performs a detection process and a recognition process for detecting and recognizing objects around the vehicle 1, and other processes. For example, the detection process for detecting the objects is a process for detecting presence or absence, sizes, shapes, positions, movements, or the like of the objects. For example, the recognition process for recognizing the objects is a process for recognizing attributes of the objects such as types, or identifying a specific object. However, the detection process and the recognition process are not necessarily processes clearly separable from each other, but may overlap with each other in some cases.

For example, the recognition unit 73 detects the objects around the vehicle 1 by clustering which classifies point clouds based on sensor data obtained by the radar 52, the LiDAR 53, or the like into clusters according to point clouds. In this manner, the presence or absence, the sizes, the shapes, and the positions of the objects around the vehicle 1 are detected.

For example, the recognition unit 73 detects movements of the objects around the vehicle 1 by tracking movements of the clusters of the point clouds classified by clustering. In this manner, speeds and traveling directions (movement vectors) of the objects around the vehicle 1 are detected.

For example, the recognition unit 73 recognizes vehicles, humans, bicycles, obstacles, structures, roads, traffic lights, traffic signs, road signs, and the like on the basis of image data supplied from the camera 51. Moreover, the recognition unit 73 may recognize the types of the objects around the vehicle 1 by performing a recognition process such as semantic segmentation.

For example, the recognition unit 73 is capable of performing a recognition process for recognizing traffic rules around the vehicle 1 on the basis of a map accumulated in the map information accumulation unit 23, a self-position estimation result obtained by the self-position estimation unit 71, and an object recognition result around the vehicle 1 obtained by the recognition unit 73. By performing this process, the recognition unit 73 is capable of recognizing positions and states of the traffic lights, details of the traffic signs and the road signs, details of traffic regulations, travelable lanes, and the like.

For example, the recognition unit 73 is capable of performing a recognition process for recognizing an environment around the vehicle 1. Possible examples of the surrounding environment corresponding to a recognition target by the recognition unit 73 include a weather, a temperature, a humidity, a brightness, a road surface state, and the like.

The behavior planning unit 62 creates a behavior plan of the vehicle 1. For example, the behavior planning unit 62 performs processes for global path planning and path tracking to create the behavior plan.

Note that the global path planning is a process for planning a rough path from a start to a goal. This global path planning includes a process called local path planning, which is a process for creating a path near the vehicle 1 and enabling safe and smooth traveling of the vehicle 1 in consideration of motion characteristics of the vehicle 1 in the planned path.

The path tracking is a process for planning actions for achieving safe and accurate traveling on the path planned by the global path planning within a planned time. For example, the behavior planning unit 62 is capable of calculating a target speed and a target angular speed of the vehicle 1 on the basis of a result of this path tracking process.

The action control unit 63 controls actions of the vehicle 1 so as to achieve the behavior plan created by the behavior planning unit 62.

For example, the action control unit 63 performs acceleration-deceleration control and direction control by controlling a steering control unit 81, a brake control unit 82, and a driving control unit 83 included in the vehicle control unit 32 described below to enable the vehicle 1 to travel on a local path calculated by the local path planning. For example, the action control unit 63 performs cooperative control aimed at exertion of ADAS functions such as collision avoidance or shock mitigation, following traveling, speed maintaining traveling, warning of a collision with the own vehicle, and warning of lane departure of the own vehicle. For example, the action control unit 63 performs cooperative control aimed at autonomous driving for achieving autonomous traveling without operation by the driver, or the like.

The DMS 30 performs an authentication process for authenticating the driver, a recognition process for recognizing a state of the driver, and other processes on the basis of sensor data received from the inside sensor 26, input data input to the HMI 31 described below, and the like. Possible examples of the state of the driver corresponding to a recognition target include a physical condition, a wakefulness level, a concentration level, a fatigue level, a visual line direction, a drunkenness level, driving manipulation, a posture, and the like.

Note that the DMS 30 may be configured to perform an authentication process for authenticating an occupant other than the driver, and a recognition process for recognizing a state of this occupant. Moreover, for example, the DMS 30 may perform a recognition process for recognizing a situation inside the vehicle on the basis of sensor data received from the inside sensor 26. Possible examples of the situation inside the vehicle corresponding to a recognition target include a temperature, a humidity, a brightness, a smell, and the like.

The HMI 31 inputs various data, instructions, and the like, and presents various data to the driver and the like.

An outline of data input performed by the HMI 31 will be explained. The HMI 31 includes an input device for manual input of data. The HMI 31 generates input signals on the basis of data, instructions, and the like input via the input device, and supplies the generated input signals to the respective components of the vehicle control system 11. For example, the HMI 31 includes a touch panel, a button, a switch, a lever, and other operating elements as the input device. In addition, the HMI 31 may further include an input device for inputting information by a method other than manual operation, such as voices and gestures. Moreover, the HMI 31 may include, as the input device, a remote control device using infrared light or radio waves, or an external connection device, such as a mobile device and a wearable device, capable of responding to operation of the vehicle control system 11, for example.

An outline of data presentation by the HMI 31 will be explained. The HMI 31 generates visual information, auditory information, and haptic information for the occupant or the outside of the vehicle. Moreover, the HMI 31 performs output control for controlling output of respective items of the generated information, output details, output timing, output methods, and the like. For example, as the visual information, the HMI 31 generates and outputs information indicated by an image or light such as an operation screen, state display of the vehicle 1, warning display, and a monitoring image presenting a situation around the vehicle 1. Moreover, for example, as the auditory information, the HMI 31 generates and outputs information indicated by sound such as voice guidance, warning sound, and a warning message. Furthermore, for example, as the haptic information, the HMI 31 generates and outputs information given to a tactile sense of the occupant in the form of force, vibration, movement, or the like.

For example, a display device which presents the visual information by displaying an image, and a projector device which presents the visual information by projecting an image are applicable to an output device of the HMI 31 for outputting the visual information. Note that the display device is not limited to a display device having an ordinary display, but may be a device which displays the visual information within a visual field of the occupant, such as a head-up display, a transmissive display, and a wearable device having an AR (Augmented Reality) function, for example. Moreover, the output device of the HMI 31 for outputting the visual information may be a display device included in a navigation device, an instrument panel, a CMS (Camera Monitoring System), an electron mirror, a lamp, or the like provided on the vehicle 1.

For example, an audio speaker, a headphone, and an earphone are applicable to an output device of the HMI 31 for outputting the auditory information.

For example, a haptics element using a haptics technology is applicable to an output device of the HMI 31 for outputting the haptic information. For example, the haptics element is provided on a portion in contact with the occupant on the vehicle 1, such as a steering wheel and a seat.

The vehicle control unit 32 controls the respective components of the vehicle 1. The vehicle control unit 32 includes the steering control unit 81, the brake control unit 82, the driving control unit 83, a body control unit 84, a light control unit 85, and a horn control unit 86.

The steering control unit 81 executes detection, control, and the like of a state of a steering system of the vehicle 1. For example, the steering system includes a steering mechanism having the steering wheel and the like, an electronic power steering, and others. For example, the steering control unit 81 includes a steering ECU for controlling the steering system, an actuator for driving the steering system, and others.

The brake control unit 82 executes detection, control, and the like of a state of a brake system of the vehicle 1. For example, the brake system includes a brake mechanism having a brake pedal and the like, an ABS (Antilock Brake System), a regenerative brake mechanism, and others. For example, the brake control unit 82 includes a brake ECU for controlling the brake system, an actuator for driving the brake system, and others.

The driving control unit 83 executes detection, control, and the like of a state of a driving system of the vehicle 1. For example, the driving system includes a driving force generation device for generating driving force of an accelerator pedal, an internal combustion engine, a driving motor, and the like, a driving force transmission mechanism for transmitting the driving force to the wheels, and others. For example, the driving control unit 83 includes a driving ECU for controlling the driving system, an actuator for driving the driving system, and others.

The body control unit 84 executes detection, control, and the like of a state of a body system of the vehicle 1. For example, the body system includes a keyless entry system, a smart key system, an automatic window device, power seats, an air conditioner, airbags, seat belts, a gear shift, and others. For example, the body control unit 84 includes a body ECU for controlling the body system, an actuator for driving the body system, and others.

The light control unit 85 executes detection, control, and the like of states of various types of lights of the vehicle 1. Possible examples of the lights corresponding to control targets include headlights, backlights, fog lights, turn signals, brake lights, projections, a bumper display, and the like. The light control unit 85 includes a light ECU for controlling the lights, an actuator for driving the lights, and others.

The horn control unit 86 executes detection, control, and the like of a state of a car horn of the vehicle 1. For example, the horn control unit 86 includes a horn ECU for controlling the car horn, an actuator for driving the car horn, and others.

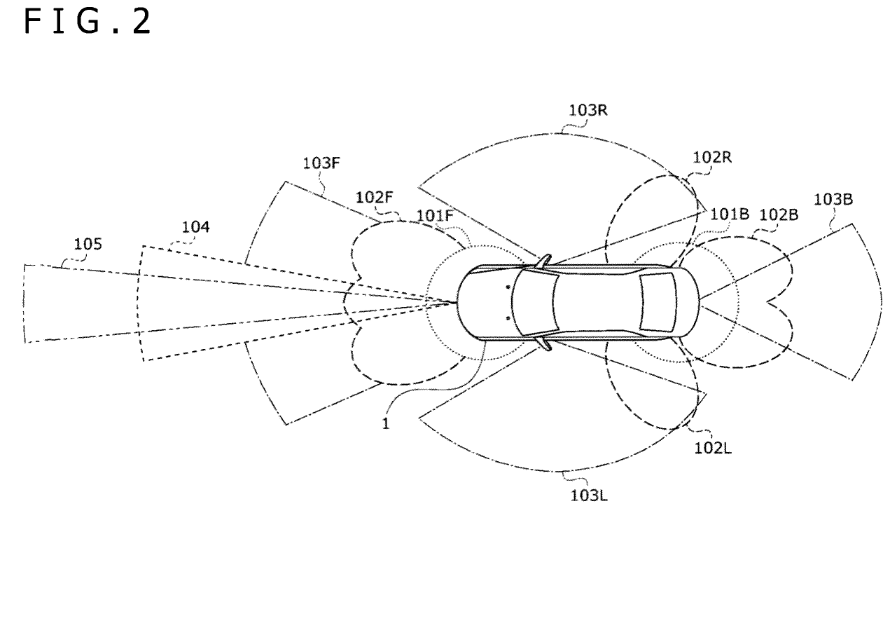

FIG. 2 is a diagram depicting an example of sensing regions formed by the camera 51, the radar 52, the LiDAR 53, the ultrasonic sensor 54, and others included in the outside recognition sensor 25 in FIG. 1. Note that FIG. 2 schematically illustrates a state of the vehicle 1 viewed from above. The left end side corresponds to the front end (front) side of the vehicle 1, while the right end side corresponds to the rear end (rear) side of the vehicle 1.

A sensing region 101F and a sensing region 101B are examples of a sensing region of the ultrasonic sensor 54. The sensing region 101F is an area located around the front end of the vehicle 1 and covered by a plurality of the ultrasonic sensors 54. The sensing region 101B is an area located around the rear end of the vehicle 1 and covered by the plurality of ultrasonic sensors 54.

For example, sensing results obtained in the sensing region 101F and the sensing region 101B are available for parking assistance for the vehicle 1.

A sensing region 102F to a sensing region 102B are examples of a sensing region of the radar 52 for a short distance or a middle distance. The sensing region 102F located in front of the vehicle 1 covers an area reaching a position farther than the sensing region 101F. The sensing region 102B located at the back of the vehicle 1 covers an area reaching a position farther than the sensing region 101B. The sensing region 102L covers an area around the back of a left side surface of the vehicle 1. The sensing region 102R covers an area around the back of a right side surface of the vehicle 1.

For example, a sensing result obtained in the sensing region 102F is available for detection of a vehicle, a pedestrian, or the like existing in front of the vehicle 1. For example, a sensing result obtained in the sensing region 102B is available for a function of preventing a backward collision with the vehicle 1 or the like. For example, sensing results obtained in the sensing region 102L and the sensing region 102R are available for detection of an object located at a side blind spot of the vehicle 1 or the like.

A sensing region 103F to a sensing region 103B are examples of a sensing region formed by the camera 51. The sensing region 103F located in front of the vehicle 1 covers an area reaching a position farther than the sensing region 102F. The sensing region 103B located at the back of the vehicle 1 covers an area reaching a position farther than the sensing region 102B. The sensing region 103L covers an area around the left side surface of the vehicle 1. The sensing region 103R covers an area around the right side surface of the vehicle 1.

For example, a sensing result obtained in the sensing region 103F is available for recognition of a traffic light or a traffic sign, a lane departure prevention support system, and an automatic headlight control system. For example, a sensing result obtained in the sensing region 103B is available for parking assistance and a surround view system. For example, sensing results obtained in the sensing region 103L and the sensing region 103R are available for a surround view system.

A sensing region 104 is an example of a sensing region of the LiDAR 53. The sensing region 104 located in front of the vehicle 1 covers an area reaching a position farther than the sensing region 103F. In addition, the sensing region 104 has a narrower range in the left-right direction than the sensing region 103F.

For example, a sensing result obtained in the sensing region 104 is available for detection of an object such as a surrounding vehicle.

A sensing region 105 is an example of a sensing region of the radar 52 for a long distance. The sensing region 105 located in front of the vehicle 1 covers an area reaching a position farther than the sensing region 104. In addition, the sensing region 105 has a narrower range in the left-right direction than the sensing region 104.

For example, a sensing result obtained in the sensing region 105 is available for ACC (Adaptive Cruise Control), emergency braking, collision avoidance, and the like.

Note that the sensing regions of the respective sensors included in the outside recognition sensor 25, i.e., the camera 51, the radar 52, the LiDAR 53, and the ultrasonic sensor 54, may have various configurations other than the configuration in FIG. 2. Specifically, the ultrasonic sensor 54 may also sense the sides of the vehicle 1, and the LiDAR 53 may sense the back of the vehicle 1. Moreover, installation positions of the respective sensors are not limited to the positions specified in the respective foregoing examples. Furthermore, either one sensor or a plurality of sensors may be provided to constitute each of the sensors.

### 2. Embodiment

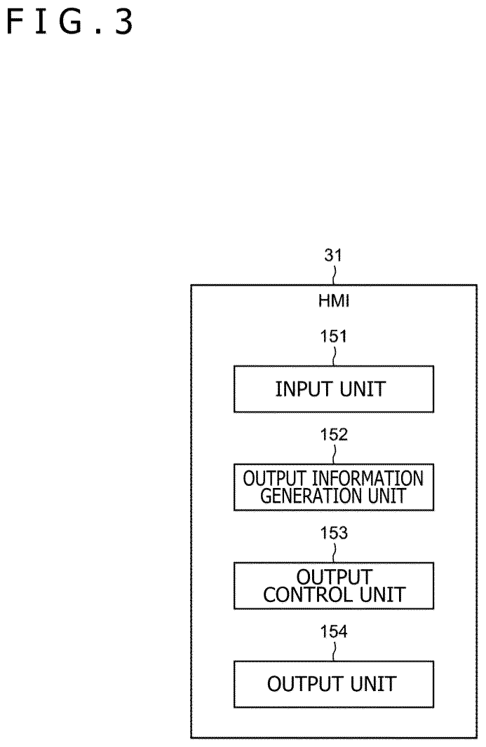

An embodiment according to the present technology will be subsequently described with reference to FIGS. 3 to 59.

### <Detailed Configuration Example of HMI 31>

FIG. 3 depicts a detailed configuration example of the HMI 31 in FIG. 1.

The HMI 31 includes an input unit 151, an output information generation unit 152, an output control unit 153, and an output unit 154.

The input unit 151 includes an input device for manual input of data, and is configured to generate input signals on the basis of data, instructions, and the like input via the input device, and supply the generated input signals to the respective components of the vehicle control system 11.

The output information generation unit 152 generates at least any one of visual information, auditory information, and haptic information for the occupant or the outside of the vehicle.

The output control unit 153 executes control of output of the output unit 154 for outputting information generated by the output information generation unit 152. For example, the output control unit 153 superimposes visual information associated with assistance for driving by the driver on at least either an area within a visual field of the driver, or an image indicating surroundings of the vehicle and presented to the driver (hereinafter referred to as a surrounding image) on the basis of at least any one of a sensing result associated with the surroundings of the vehicle 1 and obtained by the outside recognition sensor 25, information acquired from the outside, and information accumulated on the vehicle 1. For example, the information acquired from the outside contains various types of maps, such as a high-definition map and an autonomous driving map. For example, the information accumulated on the vehicle 1 contains various types of maps accumulated in the map information accumulation unit 23.

The output unit 154 includes an output device which outputs at least any one of visual information, auditory information, and haptic information, and outputs at least any one of the visual information, the auditory information, and the haptic information.

Incidentally, while not depicted in the figure, the output unit 154 includes speakers provided at respective doors or the like of the vehicle 1, for example, to realize 360-degree real audio. For example, the 360-degree real audio thus realized presents videos, music, and the like enjoyable inside the vehicle with immersive sounds. Moreover, the 360-degree real audio can issue an alert of a position of a dangerous object, such as an obstacle existing around the vehicle 1, by indicating an output direction of sound.

### <Configuration Example of Display Inside Vehicle>

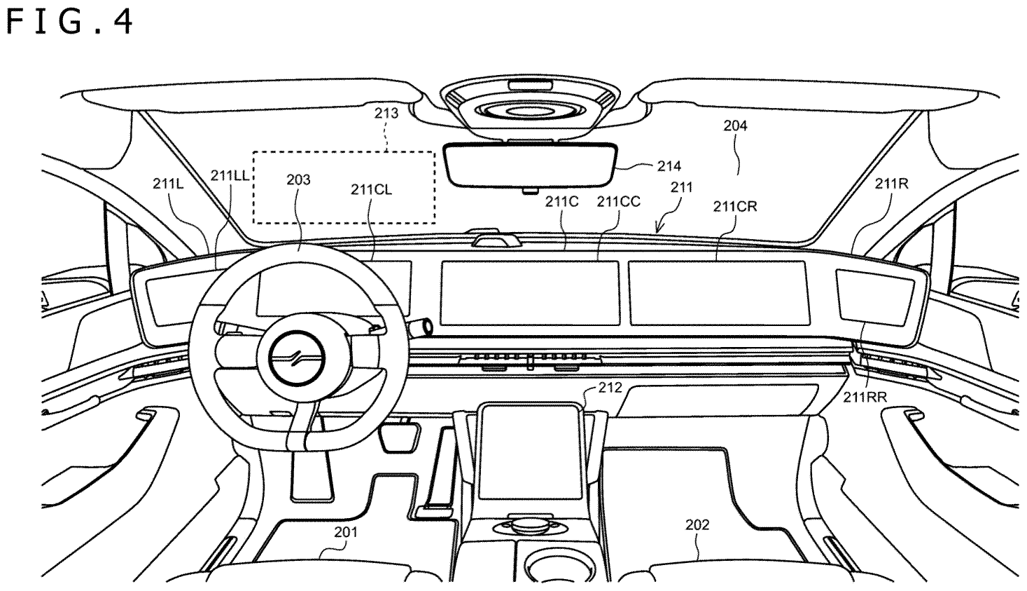

Described next with reference to FIG. 4 will be a configuration example of a display (display section) provided inside the vehicle 1, and constituting a part of the output unit 154 of the HMI 31 to form a display system of the vehicle 1. FIG. 4 is a schematic diagram depicting a front part inside the vehicle.

A center display 211, a console display 212, a head-up display (only a display 213 is depicted), and a digital rear mirror 214 are provided inside the vehicle.

The center display 211 provided in front of a driver's seat 201 and a passenger seat 202 extend in the left-right direction on a front surface of a dashboard. The center display 211 is roughly divided into a left end section 211L, a center section 211C, and a right end section 211R on the basis of directions of the display. Specifically, the center display 211 includes the left end section 211L, the center section 211C, and the right end section 211R having directions different from each other, and connected in the left-right direction to be integrated with each other. Display may be achieved either independently for each of the left end section 211L, the center section 211C, and the right end section 211R, or by the respective sections integrated with each other for unified display.

The center section 211C provided in front of the driver's seat 201 and the passenger seat 202 extends in the left-right direction from an area around a left end of the driver's seat 201 to an area around a right end of the passenger seat 202, and faces backward (to the back of the vehicle 1) as viewed from the driver's seat 201 or the passenger seat 202. In addition, the center section 211C faces in a direction slightly diagonal toward above. In this configuration, each of incidence angles of visual lines of the driver sitting on the driver's seat 201 and the occupant sitting on the passenger seat 202, both seeing the center section 211C, approaches the vertical direction. Accordingly, visibility improves.

The left end section 211L and the right end section 211R are provided substantially in symmetric positions at left and right ends of the center display 211, respectively. The left end section 211L is bended inward (toward the inside of the vehicle) at the left end of the center display 211 to form an angle in an inside direction with respect to the center section 211C, and faces diagonally rightward to the back (diagonally rightward to the back of the vehicle 1) as viewed from the driver's seat 201 or the passenger seat 202. The right end section 211R is bended inward (toward the inside of the vehicle) at the right end of the center display 211 to form an angle in the inside direction with respect to the center section 211C, and faces diagonally leftward to the back (diagonally leftward to the back of the vehicle 1) as viewed from the driver's seat 201 or the passenger seat 202.

For example, the angle of the left end section 211L with respect to the center section 211C is adjusted such that a reflection angle of a visual line of a typical driver for an incidence angle into the left end section 211L faces in an appropriate direction diagonally leftward to the back of the vehicle 1. For example, the angle of the right end section 211R with respect to the center section 211C is adjusted such that a reflection angle of a visual line of a typical driver for an incidence angle into the right end section 211R faces in an appropriate direction diagonally rightward to the back of the vehicle 1.

The center section 211C of the center display 211 is divided into a display section 211CL in front of the driver's seat 201, a display section 211CC between the driver's seat 201 and the passenger seat 202, and a display section 211CR in front of the passenger seat 202. Note that the display section 211CL, the display section 211CC, and the display section 211CR may be connected to constitute one display section.

For example, the center section 211C of the center display 211 displays information associated with driving assistance, a surrounding image of the vehicle 1, information associated with infotainment, and the like. For example, information directed to the driver is chiefly displayed on the display section 211CL. For example, information associated with infotainment (in-vehicle infotainment), such as audios, videos, websites, and maps, is displayed on the display section 211CC. For example, information associated with infotainment directed to the occupant on the passenger seat is displayed on the display section 211CR.

A display section 211LL is provided at the left end section 211L of the center display 211. A display section 211RR is provided at the right end section 211R of the center display 211.

Each of the display section 211LL and the display section 211RR chiefly constitutes a digital outer mirror (electronic side mirror) as an alternative of a side mirror in the past. Specifically, each of the display section 211LL and the display section 211RR constitutes a CMS. For example, the display section 211LL displays an image captured by the camera 51 and indicating an area diagonally leftward to the back of the vehicle 1. The display section 211RR displays an image captured by the camera 51 and indicating an area diagonally rightward to the back of the vehicle 1.

The console display 212 is provided on a console formed between the driver's seat 201 and the passenger seat 202 and located below the center section 211C of the center display 211.

For example, the console display 212 includes a two-dimensional or three-dimensional touch panel, and is operable by contact or approach of a finger or the like to the touch panel. The console display 212 faces the back of the vehicle 1. Moreover, the console display 212 faces diagonally upward at an angle substantially similar to the angle of the center section 211C of the center display 211. This configuration offers a sense of unification of the center display 211 and the console display 212 to be continuously connected to each other. Furthermore, visibility of the console display 212 improves similarly to the center section 211C of the center display 211.

For example, the console display 212 displays an operation screen through which information displayed on the center display 211 is operable, an operation screen through which an air conditioner unit inside the vehicle is operable, and the like.

As depicted in FIG. 4, the head-up display includes a display 213 provided in front of the driver's seat 201 (hereinafter referred to as a HUD display 213). For example, the HUD display 213 may be constituted by a part of a windshield 204, or may be provided separately from the windshield 204. In the latter case, the HUD display 213 is bonded to the windshield 204, for example. Thereafter, visual information is projected on the HUD display 213 to superimpose the visual information within the visual field of the driver by using an AR technology.

For example, the HUD display 213 displays information associated with driving assistance.

Note that a display range of the HUD display 213 is expected to expand in the future. For example, the display range of the HUD display 213 is expected to expand to an area around an upper end of the windshield 204, or to areas around left and right ends of the windshield 204.

The digital rear mirror 214 is provided in place of a rear-view mirror (rearview mirror) in the past, and is also called a smart room mirror. Similarly to the rear-view mirror in the past, the digital rear mirror 214 is provided at a position slightly in front of an area around the upper end and the center of the windshield 204, and located above the center section 211C of the center display 211.

For example, the digital rear mirror 214 displays an image captured by the camera 51 and indicating the back of the vehicle 1.

### <Driving Assistance Process>

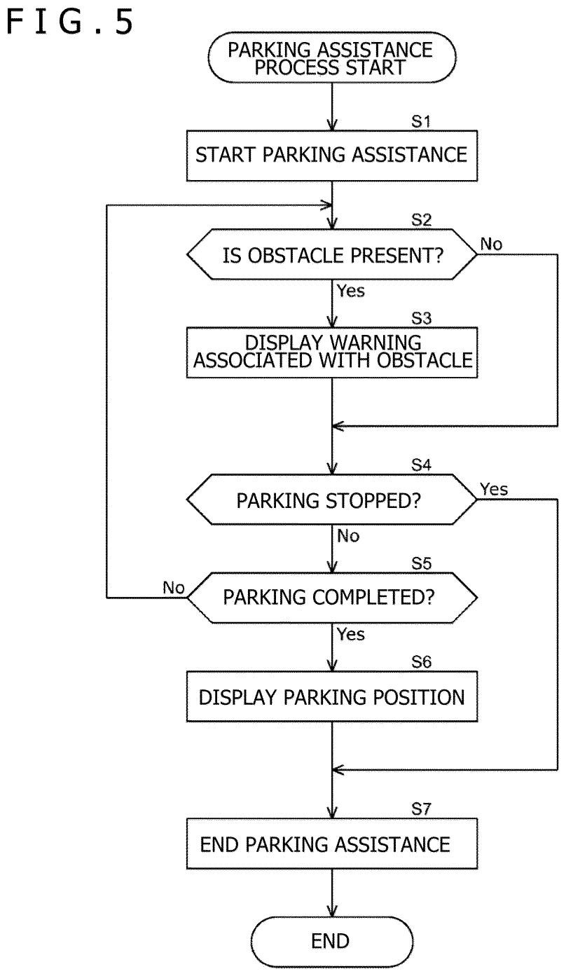

Described next with reference to FIGS. 5 to 59 will be an example of a driving assistance process executed by the vehicle 1.

Note that directions included in images displayed on the respective displays of the vehicle 1 will be hereinafter basically expressed on the basis of the direction of the vehicle 1. For example, a left direction in a back image captured at the back of the vehicle 1 corresponds to a right direction for the vehicle 1 (as viewed from the driver inside the vehicle 1). Accordingly, this direction will be expressed as a right direction.

### <Parking Assistance Process>

Initially described with reference to a flowchart in FIG. 5 will be a parking assistance process executed by the vehicle 1.

For example, this process starts in response to a case where the driver executes operation for parking the vehicle 1, a case where the recognition unit 73 detects approach of the vehicle 1 to a planned parking position, or other cases.

In step S1, the output unit 154 starts parking assistance under control by the output control unit 153. For example, the output unit 154 starts display of visual information associated with parking assistance under control by the output control unit 153. Note that specific examples of the visual information associated with parking assistance will be described below.

In step S2, the recognition unit 73 determines whether or not an obstacle is present. Specifically, the recognition unit 73 executes a detection process for detecting an obstacle around a position at which the vehicle 1 is to be parked on the basis of sensor data received from the outside recognition sensor 25 or the like. For example, the obstacle herein is not only an object which may come into a collision or contact with the vehicle 1 during parking, but also an object located at such a position as to possibly come into a collision or contact with a back door of the vehicle 1 when the back door is opened after parking. In a case where the recognition unit 73 determines that any obstacle is present on the basis of a result of the obstacle detection process, the process proceeds to step S3.

In step S3, the output unit 154 displays warning associated with the obstacle under control by the output control unit 153. Note that specific examples of the warning display will be described below.

Thereafter, the process proceeds to step S4.

Meanwhile, in a case where no obstacle is present in step S2, the process proceeds to step S4 while skipping the processing in step S3.

In step S4, the vehicle control unit 32 determines whether or not parking has been stopped. In a case of determination that parking has not been stopped, the process proceeds to step S5.

In step S5, the vehicle control unit 32 determines whether or not parking has been completed. In a case of determination that parking has not yet been completed, the process returns to step S2.

Thereafter, the processing from step S2 to step S5 is repeatedly executed until determination that parking has been stopped in step S4, or determination that parking has been completed in step S5.

Meanwhile, in a case of determination that parking has been completed in step S5, the process proceeds to step S6.

In step S6, the output unit 154 displays a parking position under control by the output control unit 153. Note that specific examples of the parking position display will be described below.

Thereafter, the process proceeds to step S7.

Meanwhile, in a case of determination that parking has been stopped in step S4, the process proceeds to step S7 while skipping the processing in step S5 and step S6.

In step S7, the output unit 154 ends parking assistance under control by the output control unit 153. For example, the output unit 154 ends display of the visual information associated with parking assistance under control by the output control unit 153.

Thereafter, the parking assistance process ends.

### <Example of Visual Information Display During Parking Assistance>

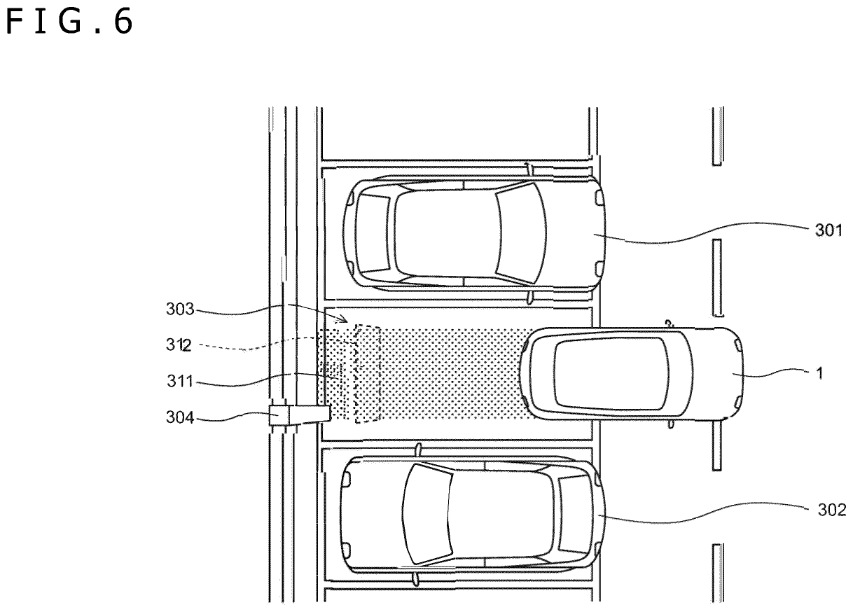

Described next with reference to FIGS. 6 to 28 will be display examples of the visual information during parking assistance.

### <First Display Example of Visual Information During Parking Assistance>

Initially described with reference to FIGS. 6 to 9 will be a first display example of the visual information during parking assistance.

Each of FIGS. 6 to 9 depicts an example of an image displayed on the display section 211CC of the center section 211C of the center display 211 during parking. Specifically, depicted in each of the figures is an example where the vehicle 1 is to be parked in a parking space 303 between a vehicle 301 and a vehicle 302. A pole 304 stands at the back left of the parking space 303.

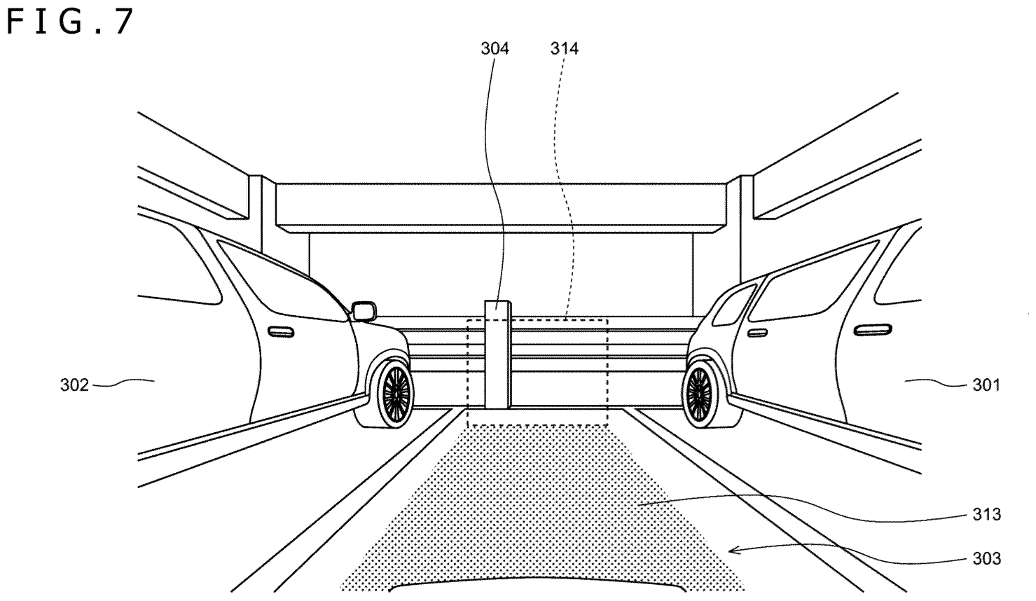

For example, images in FIGS. 6 and 7 are displayed laterally side by side on the display section 211CC of the center display 211.

In the image of FIG. 6, visual information 311 and visual information 312 are superimposed on an image around the vehicle 1 as viewed from above (hereinafter referred to as a top view image). The visual information 311 is superimposed on a road surface at the back of the vehicle 1 for guidance of a traveling direction for parking the vehicle 1. For example, a color for displaying the visual information 311 is set to semitransparent green. The visual information 312 presents a recommended position for the rear end of the vehicle 1 during parking. For example, a color for displaying the visual information 312 is set to an alerting color (e.g., semitransparent red).

In the image of FIG. 7, visual information 313 and visual information 314 are superimposed on an image at the back of the vehicle 1 (hereinafter referred to as a back image). The visual information 313 corresponding to the visual information 311 in FIG. 6 is superimposed on a road surface in the back image for guidance of a traveling direction for parking the vehicle 1. A color for displaying the visual information 313 is set to the same color as the color of the visual information 311. The visual information 314 corresponding to the visual information 312 in FIG. 6 extends in the vertical direction, and indicates a recommended position for the rear end of the vehicle 1 during parking. A color for displaying the visual information 314 is set to the same semitransparent color as the color of the visual information 312. The pole 304 and the like at the back are visible through the visual information 314. Note that the visual information 314 is indicated by only a dotted line in this figure for easy understanding of the figure.

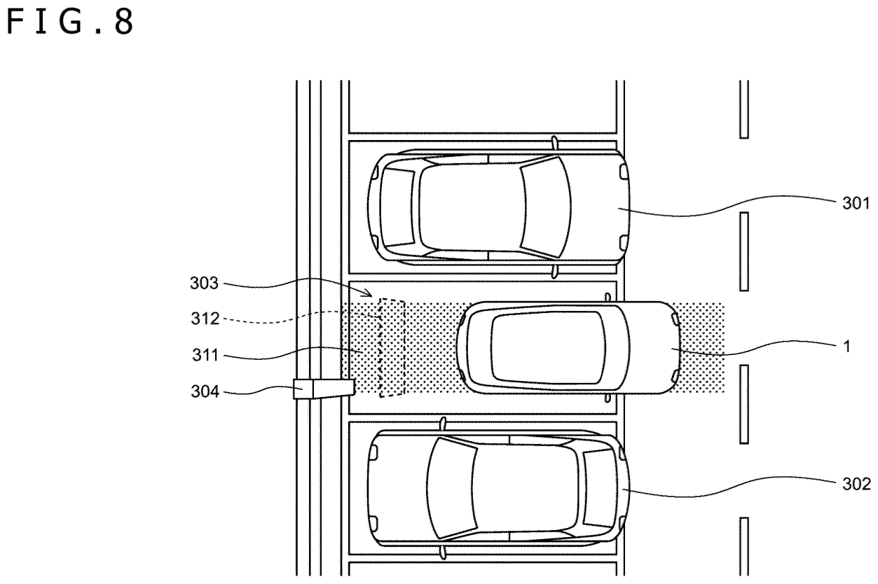

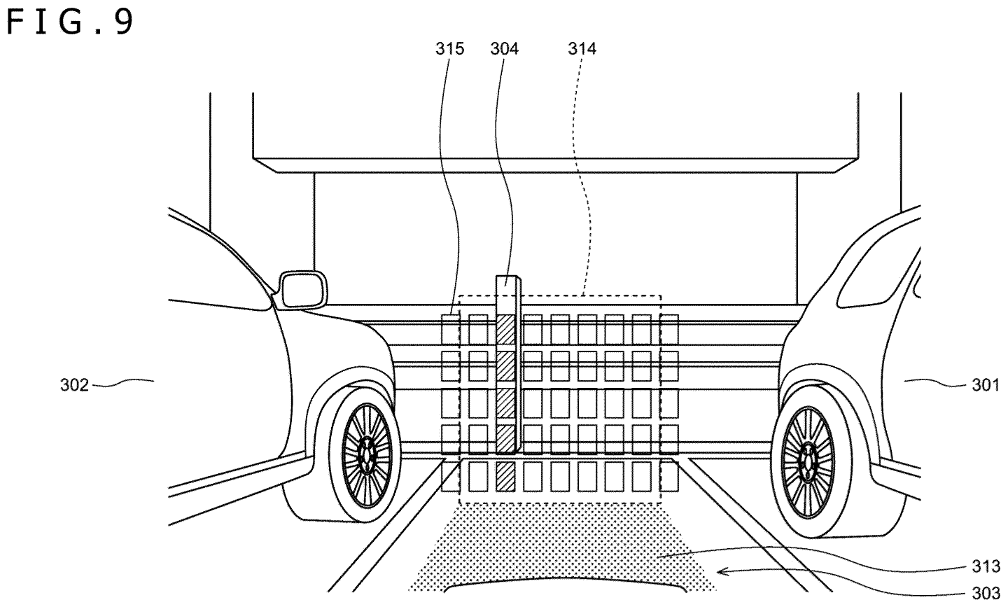

Each of FIGS. 8 and 9 depicts an example of an image displayed on the display section 211CC of the center display 211 in a case of backward moving of the vehicle 1 from the state depicted in FIGS. 6 and 7.

In FIG. 8, the visual information 311 and the visual information 312 are superimposed on the top view image similarly to FIG. 6.

In FIG. 9, the visual information 313 and the visual information 314 are superimposed on the back image similarly to FIG. 7. Visual information 315 is further superimposed on the back image. The visual information 315 contains semitransparent rectangular cells arranged in a grid pattern in such a manner as to overlap with the visual information 314. For example, the driver can recognize a width and a height of an obstacle located at the back on the basis of the rectangular cells.

For example, in a case where an obstacle is present at such a position as to possibly come into a collision or contact with the back door of the vehicle 1 in a case of opening of the back door, a display mode of the cells overlapping with this obstacle is set to a display mode different from display modes of the other cells (e.g., different color). Note that the obstacle which may come into a collision or contact with the back door include an object existing in the air, such as a branch.

In the case of this example, the pole 304 is present at such a position as to come into a collision or contact with the back door of the vehicle 1 in the case of opening of the back door. Accordingly, for example, a color for displaying the cells overlapping with the pole 304 is set to an alerting color (e.g., semitransparent red). For example, each color for displaying the other cells is set to a color representing safety (e.g., semitransparent blue).

This manner of display can prevent a collision or contact between the back door of the vehicle 1 and the obstacle at the back of the vehicle 1 at the time of careless opening of the back door after parking.

### <Second Display Example of Visual Information During Parking Assistance>

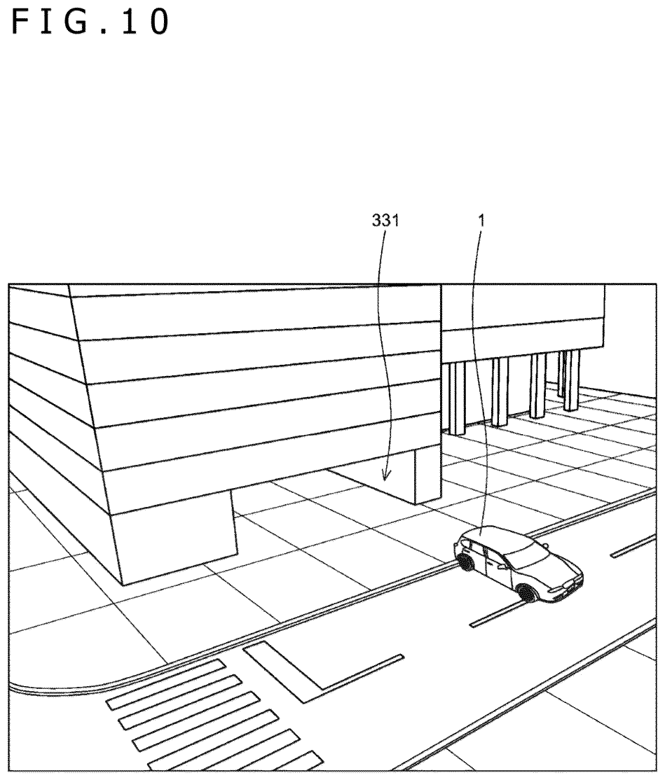

Described next with reference to FIGS. 10 to 13 will be a second display example of the visual information during parking assistance. Specifically, described will be an example of a case where the vehicle 1 is to be parked in a parking space having a low ceiling as depicted in FIG. 10.

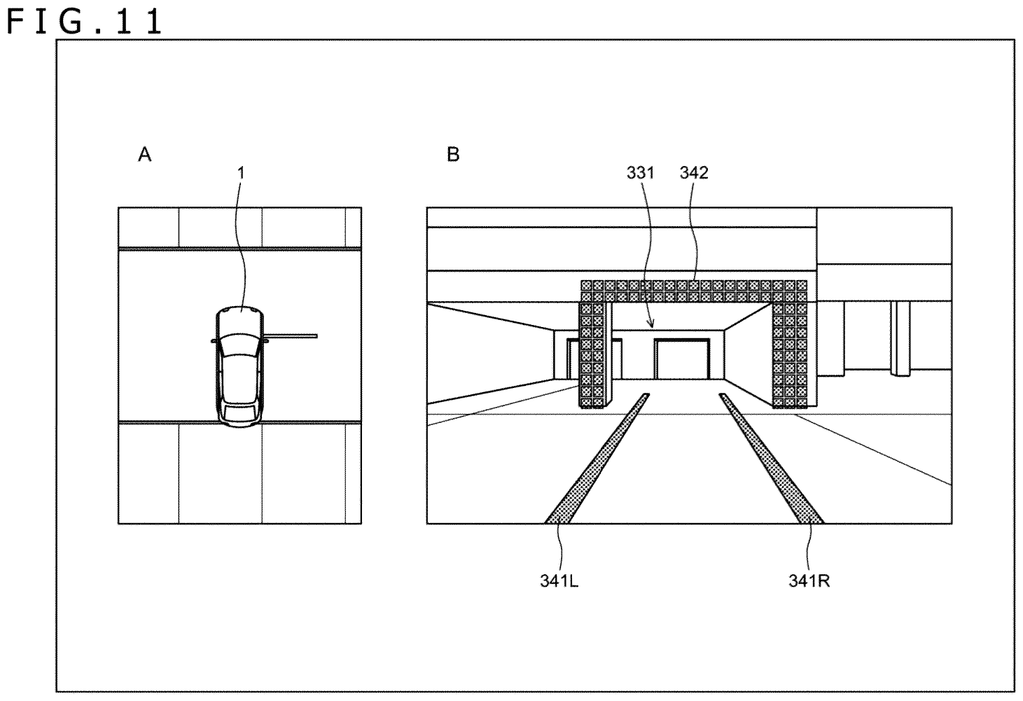

For example, images in A and B of FIG. 11 are displayed laterally side by side on the display section 211CC of the center section 211C of the center display 211.

The image in A of FIG. 11 is a top view image around the vehicle 1.

In the image in B of FIG. 11, visual information 341L, visual information 341R, and visual information 342 are superimposed on a back image of the vehicle 1.

Each of the visual information 341L and the visual information 341R contains an auxiliary line having a predetermined color (e.g., white) for guidance of a traveling direction for parking the vehicle 1. The visual information 341L and the visual information 341R are superimposed on a road surface of the back image side by side in the left-right direction while aligned with the width of the vehicle 1.

The visual information 342 indicates a range of an entrance of a parking lot by a plurality of semitransparent rectangular cells arranged along a frame of the entrance of the parking lot. This manner of display can prevent a collide or contact between the vehicle 1 and the entrance of the parking lot.

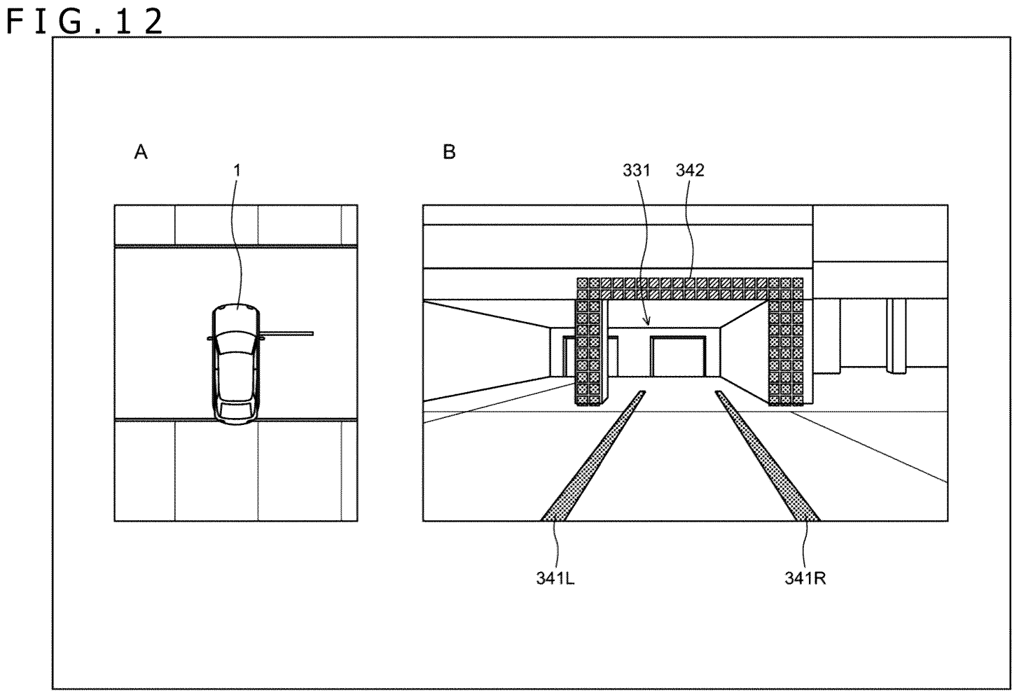

Moreover, in a case where the vehicle 1 is large in height and has an upper part which may come into a collision or contact with the entrance of the parking lot, for example, a display mode of an upper side of the visual information 342 changes as depicted in B of FIG. 12. For example, the upper side of the visual information 342 changes in color, or starts blinking. This manner of display can prevent a collide or contact between an upper end of the vehicle 1 and the entrance of the parking lot.

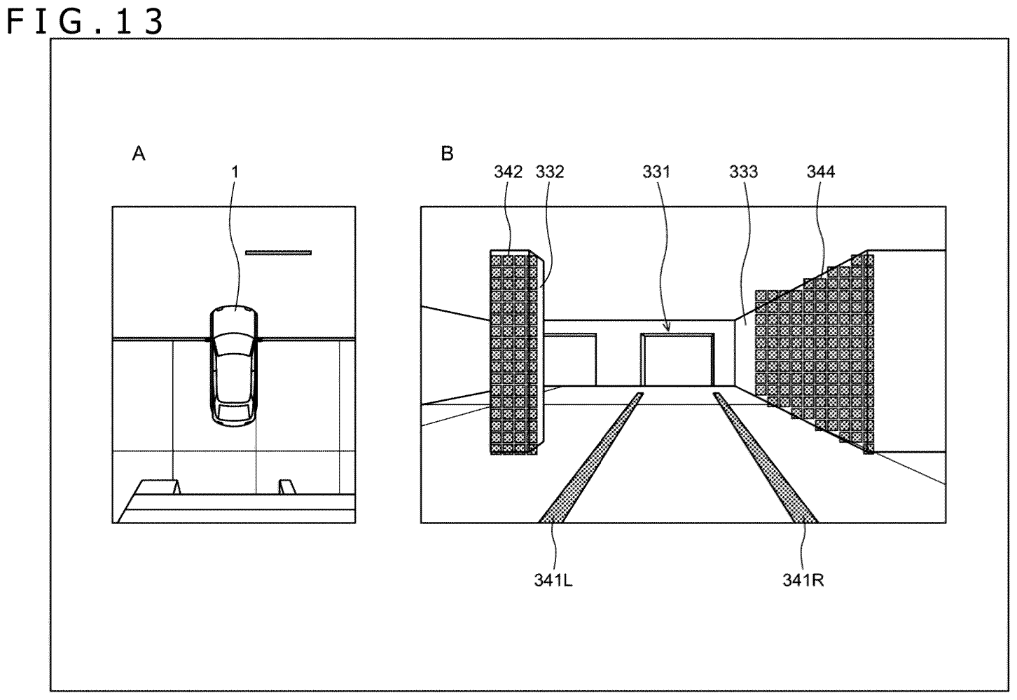

FIG. 13 depicts an example of a case where the vehicle 1 further moves backward in comparison with the states in FIGS. 11 and 12.

An image in A of FIG. 13 is a top view image around the vehicle 1.

In an image in B of FIG. 13, the visual information 341L and the visual information 341R are superimposed on the back image of the vehicle 1 similarly to B of FIG. 11 and B of FIG. 12. Moreover, visual information 343 and visual information 344 are superimposed on the back image.

The visual information 343 indicates a position and a shape of a pillar 332 located at the back right of the vehicle 1 by a plurality of rectangular cells each having a predetermined semitransparent color (e.g., yellow) and arranged on a front surface of the pillar 332. For example, each of the cells of the visual information 343 blinks in a fixed cycle to express light which moves in a predetermined direction. This manner of display improves visibility of the pillar 332 even when the visual information 343 is superimposed.

The visual information 344 indicates a position and a shape of a wall 333 located at the back left of the vehicle 1 by rectangular cells each having a predetermined semitransparent color (e.g., yellow) and arranged along the wall 333. For example, each of the cells of the visual information 344 blinks in a fixed cycle to express light which moves in a predetermined direction. This manner of display improves visibility of the wall 333 improves even when the visual information 343 is superimposed.

The manner of display described above can prevent a collision or contact between the vehicle 1 and a surrounding obstacle during parking.

### <Third Display Example of Visual Information During Parking Assistance>

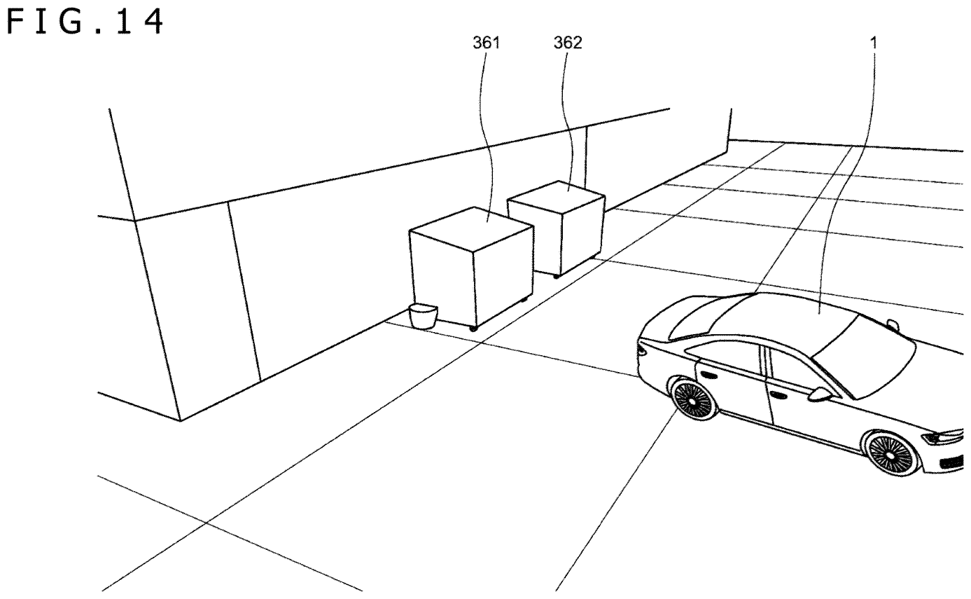

Described next with reference to FIGS. 14 to 18 will be a third example of the visual information during parking assistance. Specifically, described will be an example of a case where the vehicle 1 is to be parked at a place including garbage containers 361 and 362 at the back as depicted in FIG. 14. Note that the garbage containers 361 and 361 are disposed laterally side by side. The garbage container 361 is placed at the back of the vehicle 1. The garbage container 361 has a small projecting portion at the lower right and on the back side.

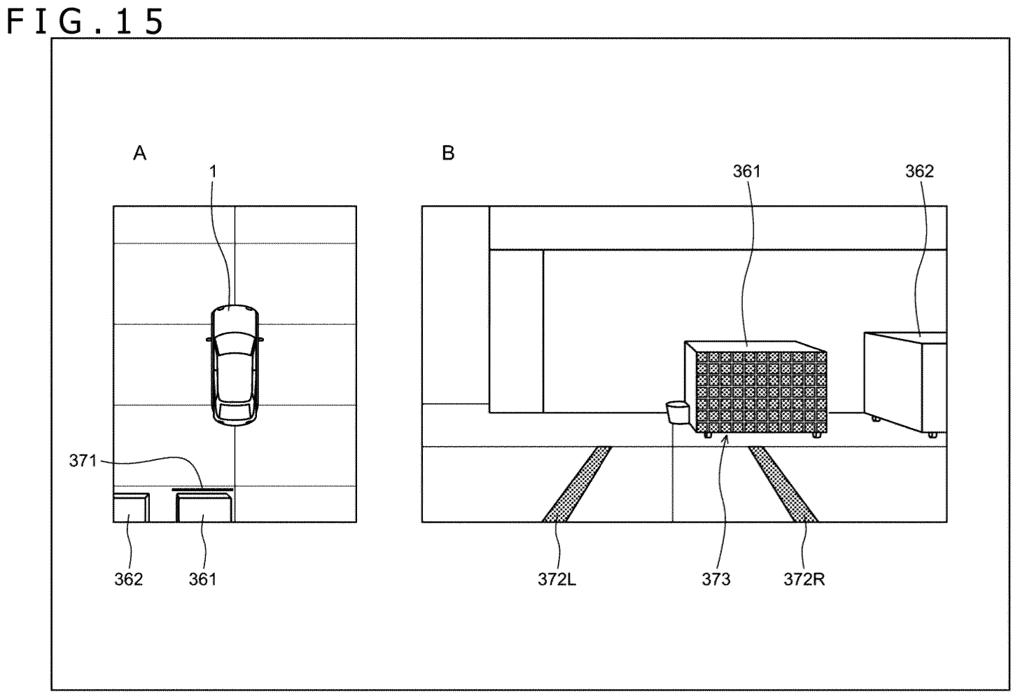

For example, images in A and B of FIG. 15 are displayed laterally side by side on the display section 211CC of the center section 211C of the center display 211.

In the image in A of FIG. 15, visual information 371 is superimposed on a top view image around the vehicle 1.

The visual information 371 is superimposed on a position slightly in front of a front surface of the garbage container 361 located within a predetermined distance range from the rear end of the vehicle 1. A color for displaying the visual information 371 which is linear is set to an alerting color (e.g., yellow).

In the image in B of FIG. 15, visual information 372L, visual information 372R, and visual information 373 are superimposed on a back image of the vehicle 1.

Each of the visual information 372L and the visual information 372R contains an auxiliary line for guidance of a traveling direction for parking the vehicle 1 similarly to the visual information 341L and the visual information 341R in FIG. 11. Each of the visual information 372L and the visual information 372R extends to a position the vehicle 1 is allowed to reach by backward movement without a collision or contact with the garbage container 361.

The visual information 373 corresponding to the visual information 371 in A of FIG. 15 indicates a position and a shape of the front surface of the garbage container 361 by rectangular cells arranged in a grid pattern on the front surface of the garbage container 361. For example, a color for displaying the respective cells is set to the same transparent color as the color of the visual information 371.

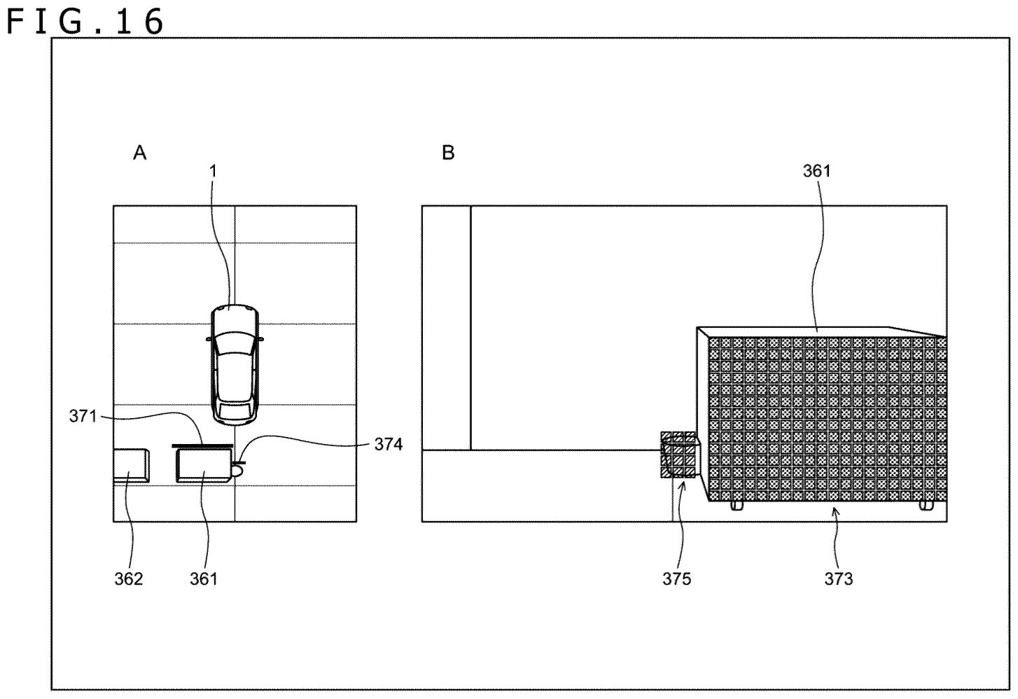

For example, when the distance between the vehicle 1 and the garbage container 361 reaches a predetermined threshold or shorter according to further approach of the vehicle 1 to the garbage container 361, images in A and B of FIG. 16 are laterally displayed side by side on the display section 211CC of the center display 211.

Comparing the image in A of FIG. 16 with the image in A of FIG. 15, the image in A of FIG. 16 is different in points that the display mode of the visual information 371 is changed, and that visual information 374 is added.

For example, the color of the visual information 371 is changed to a color indicating a danger (e.g., red).

The visual information 374 is superimposed on a position slightly in front of a front surface of the projecting portion of the garbage container 361 located within a predetermined distance range from the rear end of the vehicle 1. A color for displaying the visual information 374 which is linear is set to the similar color to the color of the visual information 371 in A of FIG. 15.

Comparing the image in B of FIG. 16 with the image in B of FIG. 15, the image in B of FIG. 16 is different in points that the display mode of the visual information 373 is changed, and that visual information 375 is added.

For example, the color of the visual information 373 is changed to a color indicating a danger (e.g., semitransparent red) similarly to the visual information 371 in A of FIG. 16.

The visual information 375 corresponding to the visual information 374 in A of FIG. 16 indicates a position and a shape of the projecting portion of the garbage container 361 by rectangular cells arranged in a grid pattern on the front surface of the projecting portion of the garbage container 361. Each color for displaying the respective cells is set to the similar color to the color of the visual information 373 in B of FIG. 15.

This manner of display enables the driver to recognize the position and the shape of the garbage container 361 corresponding to an obstacle. Moreover, this manner of display enables the driver to recognize the position allowed to be reached by backward movement of the vehicle 1, and thus can park the vehicle 1 without a collision and contact with the garbage container 361.

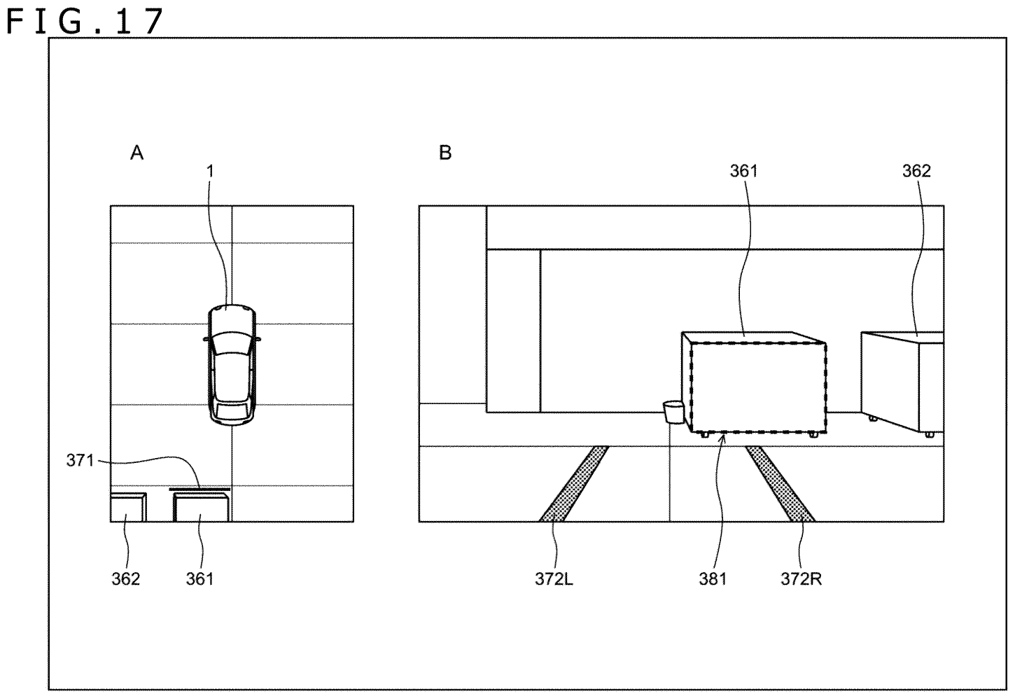

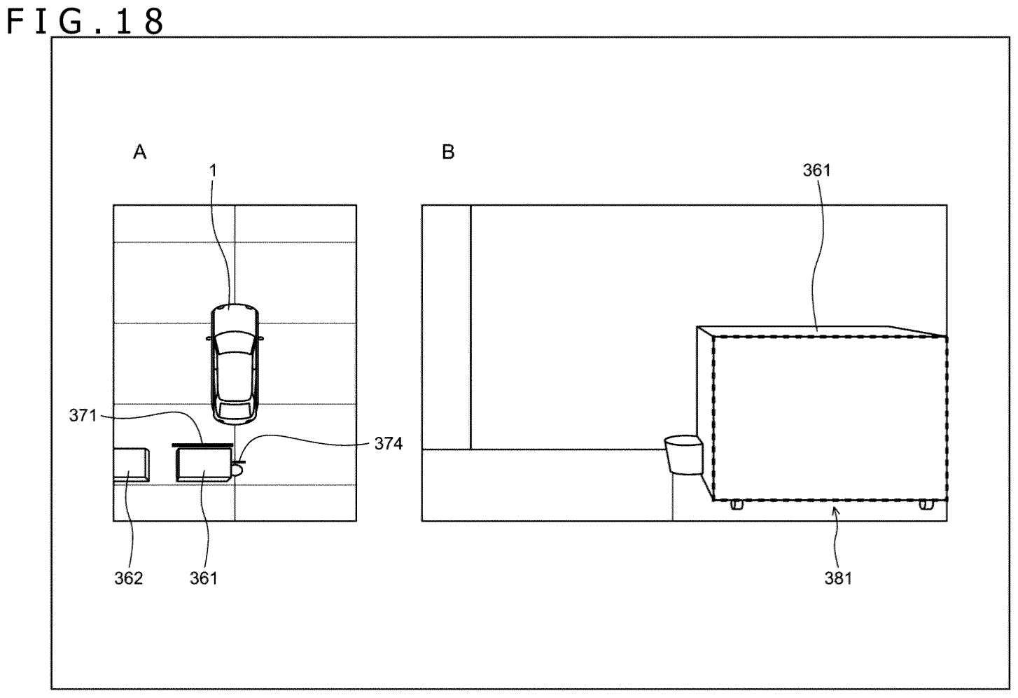

Each of FIGS. 17 and 18 depicts a modification of the visual information indicating the position and the shape of the garbage container 361.

Comparing an image in FIG. 17 with the image in FIG. 15, an image in B of FIG. 17 is different in a point that visual information 381 is superimposed instead of the visual information 373 in B of FIG. 15.

While the visual information 381 is indicated by a dotted line in the figure, the visual information 381 in a practical situation contains a rectangular frame expressed by a flow of light rotating in a predetermined direction along a contour (outer circumference) of the front surface of the garbage container 361.

A color for displaying the visual information 381 is set to an alerting color (e.g., yellow).

Comparing an image in FIG. 18 with the image in FIG. 16, an image in B of FIG. 18 is different in points that the visual information 381 is superimposed instead of the visual information 373 in B of FIG. 16, and that the visual information 375 is not displayed.

The visual information 381 has a color different from the color of the visual information 381 in B of FIG. 17, and changed to a color indicating a danger (e.g., red).

As apparent from above, the visual information 381 is superimposed on only the contour of the front surface of the garbage container 361 without covering the entire front surface. Accordingly, visibility of the garbage container 361 improves.

### <Third Display Example of Visual Information During Parking Assistance>

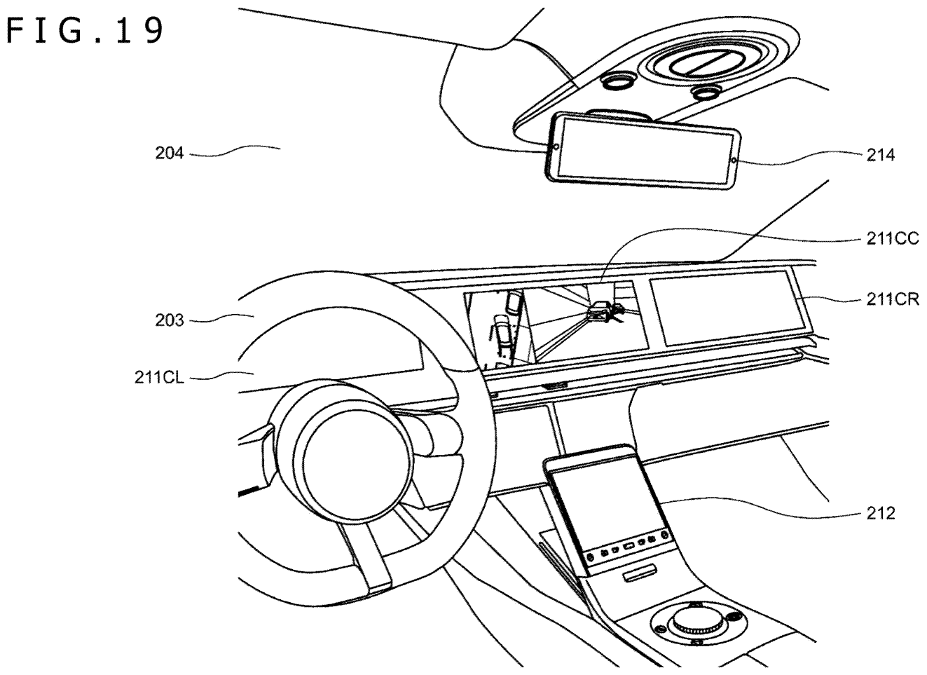

Described next with reference to FIGS. 19 to 24 will be a fourth display example of the visual information during parking assistance. Specifically, described will be an example of an image displayed on the display section 211CC of the center section 211C of the center display 211 in a case where the vehicle 1 is to be parked along a roadside as depicted in FIG. 19. A top view image around the vehicle 1 is displayed on a left part of the display section 211CC, while a back image of the vehicle 1 or an image in front of the vehicle 1 (hereinafter referred to as a front image) is displayed on a right part of the display section 211CC.

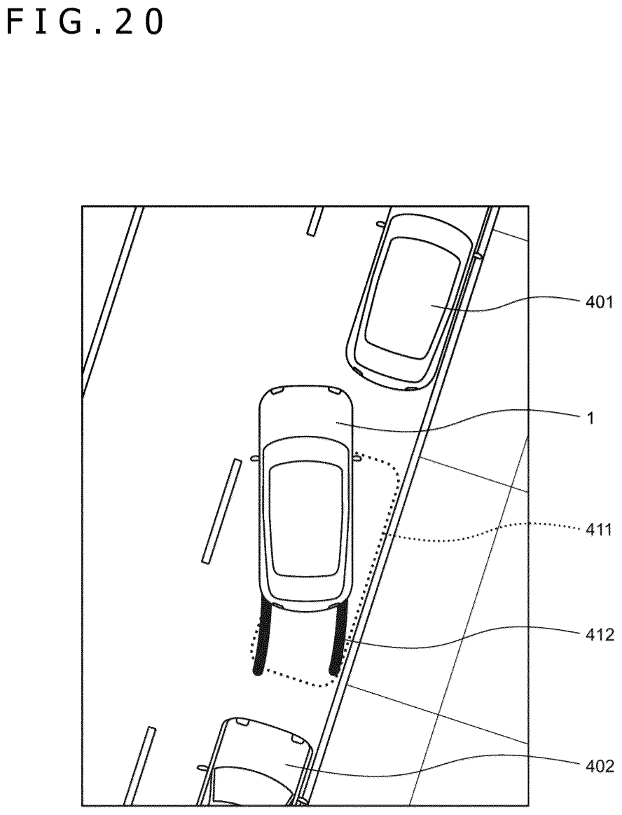

For example, in a case where the vehicle 1 is parked in parallel between a vehicle 401 and a vehicle 402, visual information 411 and visual information 412 are superimposed on the top view image as depicted in FIG. 20.

The visual information 411 indicates an appropriate parking position by a dotted frame having substantially the same size as the size of the vehicle 1 and a predetermined color (e.g., white). For example, the visual information 411 is superimposed on a road surface between the vehicle 401 and the vehicle 402 at such a position where a distance from the vehicle 401 and a distance from the vehicle 402 are substantially equal to each other.

The visual information 412 contains auxiliary lines having a predetermined color (e.g., white) and indicating a track of the vehicle 1 predicted on the basis of a current state of the vehicle 1 (e.g., a state of the steering system).

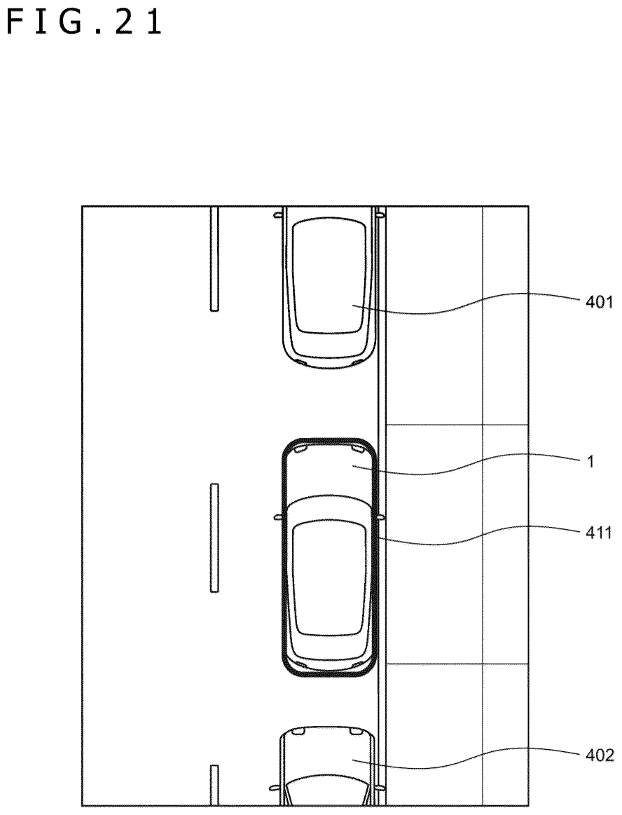

Each of FIGS. 21 to 23 indicates an example of a top view in a case where the vehicle 1 is to be parked within a space indicated by the visual information 411.

In the example of FIG. 21, the visual information 412 disappears, while a display mode of the visual information 411 changes. For example, a line type of the visual information 411 changes from a dotted line to a straight line. Note that not only the line type but also the color of the visual information 411 may change, such as from white to green or other colors.

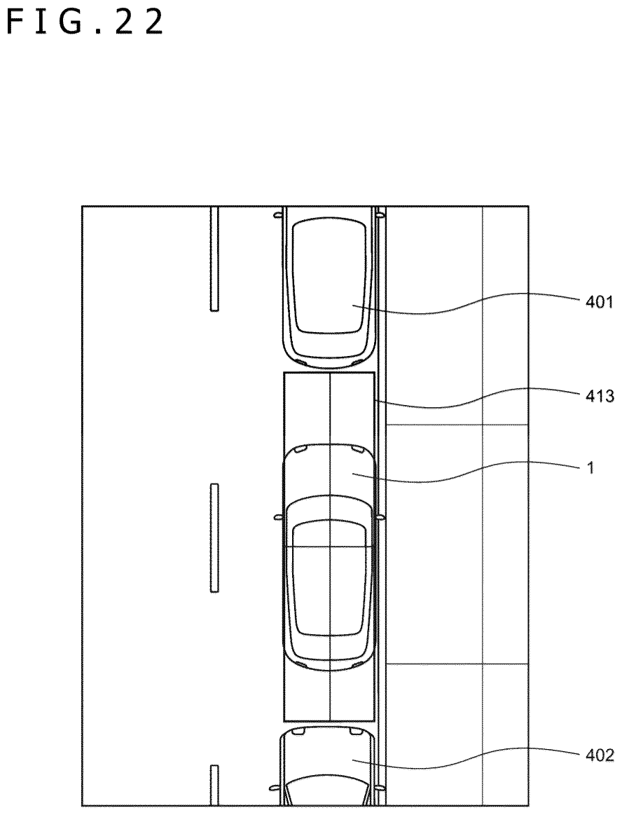

In the example of FIG. 22, the visual information 411 and the visual information 412 disappear, while visual information 413 is superimposed on the top view image. The visual information 413 contains a rectangular frame surrounding a region between the vehicle 401 and the vehicle 402 located in front of and behind the vehicle 1, and a cross-shaped auxiliary line indicating the center of the rectangular frame.

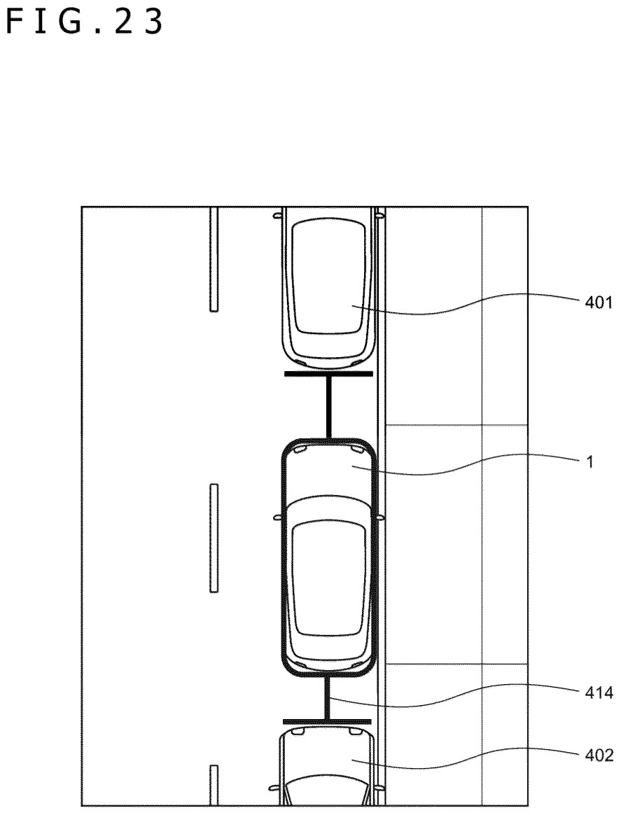

In the example of FIG. 23, the visual information 411 and the visual information 412 disappear, while visual information 414 is superimposed on the top view image. The visual information 414 contains a frame surrounding the vehicle 1, and auxiliary lines indicating a distance from the vehicle 401 and a distance from the vehicle 402 in front of and behind the frame.

The driver can recognize that the vehicle 1 has been parked at the appropriate position on the basis of the visual information depicted in each of FIGS. 21 to 23.

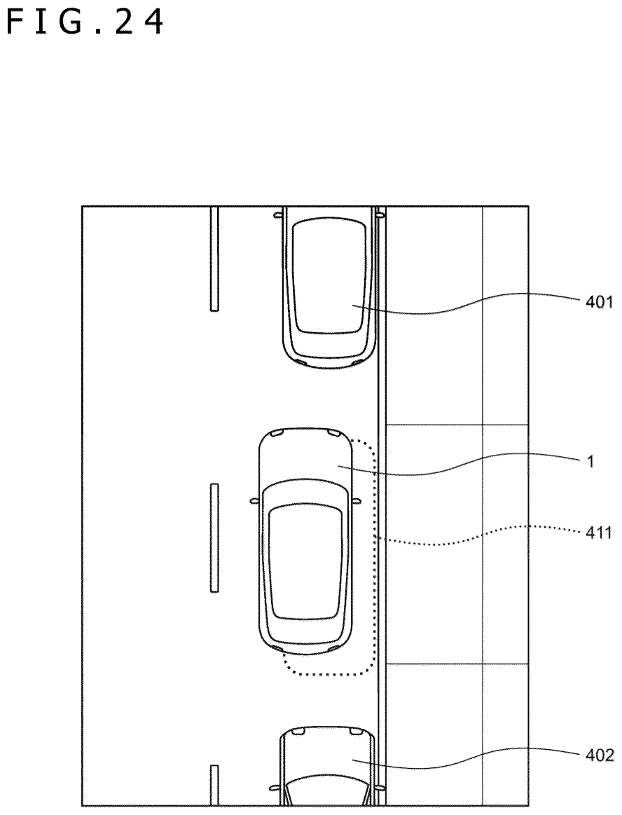

In addition, in a case where the vehicle 1 is not parked at the appropriate position, for example, the visual information 411 is kept displayed without a change of the display mode as depicted in FIG. 24. This manner of display enables the driver to recognize that the vehicle 1 is not parked at the appropriate position.

The manner of display described above enables the driver to park the vehicle 1 at an appropriate position.

### <Fifth Display Example of Visual Information During Parking Assistance>

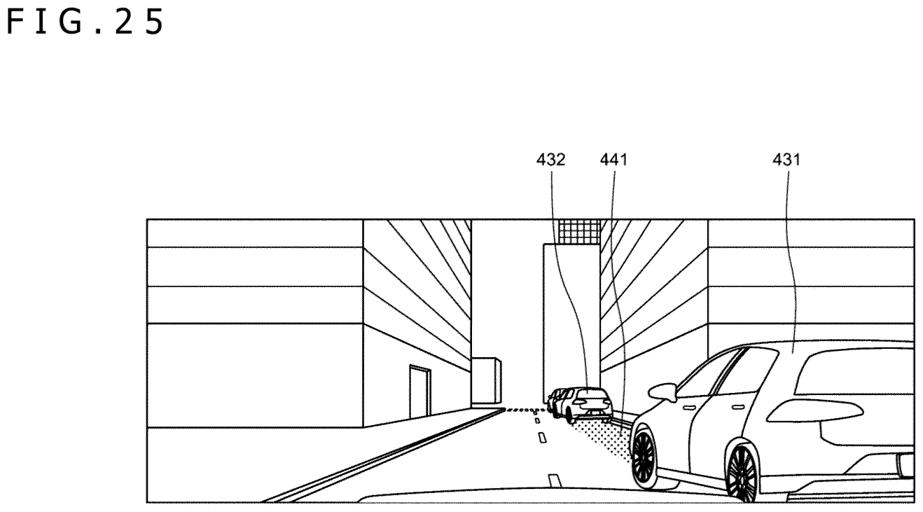

Described next with reference to FIGS. 25 to 28 will be a fifth display example of the visual information during parking assistance.

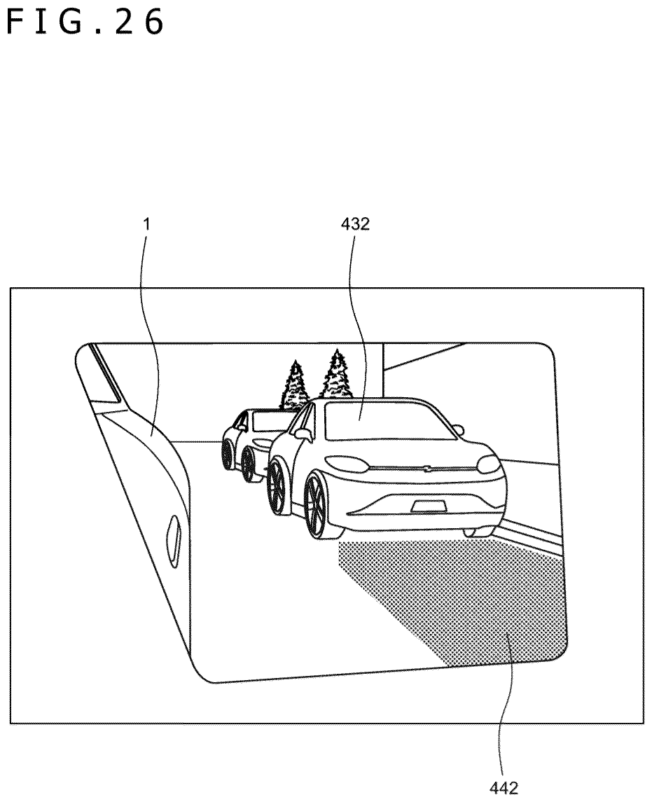

Each of FIGS. 25 and 26 depicts an example of an image displayed in a case of a search for a space available for parking.

Specifically, FIG. 25 depicts an example of an image displayed on the display section 211CC of the center section 211C of the center display 211 in a case where a space available for parking is detected between a vehicle 431 and a vehicle 432.

For example, visual information 441 is superimposed on the space available for parking in a front image of the vehicle 1. For example, the space available for parking is a space having a length larger than a full length of the vehicle 1 by a predetermined length or larger. While detailed illustrations are not given in this figure, the visual information 441 contains a cuboid gradation region which has a color gradually changing to a lighter color in an upward direction from a road surface, for example.

For example, the display mode (e.g., color) of the gradation region changes according to the size of the spacespace available for parking. For example, in a case where the difference between the full length of the space available for parking and the full length of the vehicle 1 is a predetermined threshold or larger, the color for displaying the gradation region is set to a color indicating that the parking space is sufficiently wide (e.g., semitransparent green). On the other hand, in a case where the difference between the full length of the space available for parking and the full length of the vehicle 1 is smaller than the predetermined threshold, for example, the color for displaying the gradation region is set to a color indicating that the parking space is narrow (e.g., semitransparent yellow).

FIG. 26 depicts an example of an image displayed on the display section 211RR of the right end section 211R of the center display 211 in a case where a space available for parking is detected between the vehicle 431 and the vehicle 432.

For example, visual information 442 is superimposed on the space available for parking in an image at the back right of the vehicle 1 (hereinafter referred to as a back right image). While detailed illustrations are not given in this figure, the visual information 442 contains a gradation region similar to the gradation region of the visual information 441 in FIG. 25, for example. The display mode (e.g., color) of the gradation region changes according to the width of the parking space similarly to the visual information 441.

This manner of display enables the driver to easily search a space available for parking.

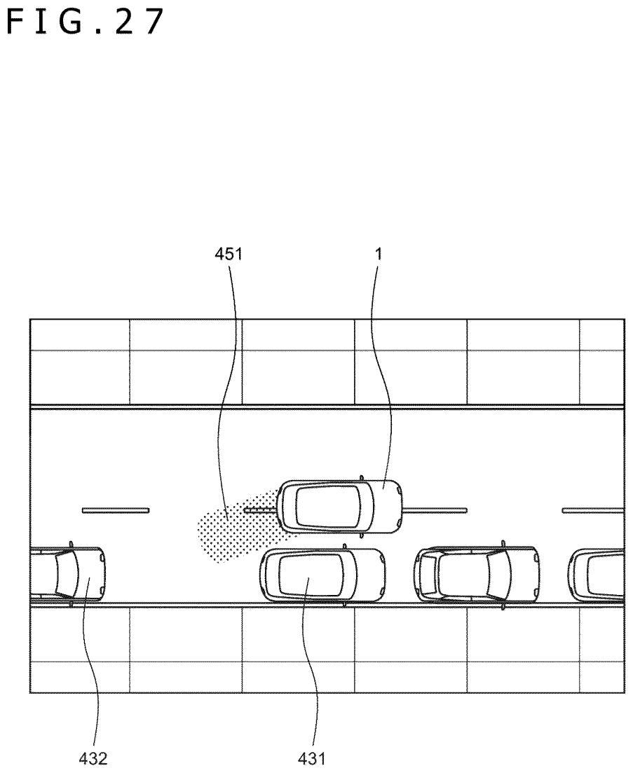

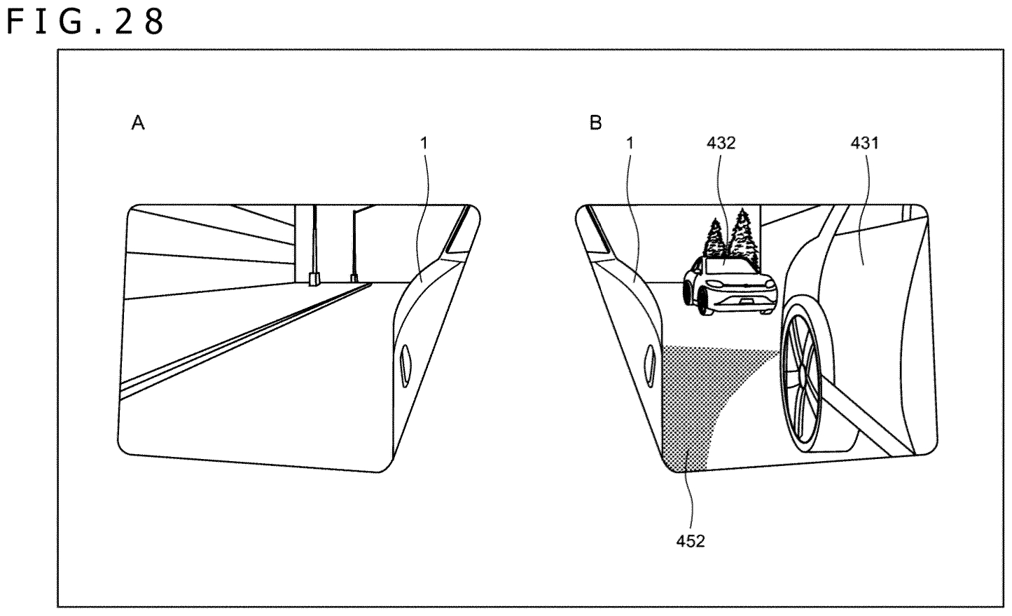

Each of FIGS. 27 and 28 depicts an example of an image displayed in a case where the vehicle 1 is to be parked in a searched space available for parking.

FIG. 27 depicts an example of an image displayed on the display section 211CC of the center section 211C of the center display 211 in a case of parallel parking between the vehicle 431 and the vehicle 432. For example, visual information 451 is superimposed on a top view image around the vehicle 1. The visual information 451 has a predetermined color (e.g., green) and represents a track of the vehicle 1 predicted on the basis of a current state of the vehicle 1 (e.g., a state of the steering system).

A of FIG. 28 depicts an example of an image indicating the back left of the vehicle 1 (hereinafter referred to as a back left image) and displayed on the display section 211LL of the left end section 211L of the center display 211 in a case of parking between the vehicle 431 and the vehicle 432. B of FIG. 28 depicts an example of a back right image of the vehicle 1 displayed on the display section 211RR of the right end section 211R of the center display 211 in a case of parking between the vehicle 431 and the vehicle 432.

For example, visual information 452 corresponding to the visual information 451 in FIG. 27 and indicating the track of the vehicle 1 predicted on the basis of the current state of the vehicle 1 is superimposed on the back right image in B of FIG. 28.

This manner of display enables the driver to park the vehicle 1 safely and easily while checking the predicted track of the vehicle 1.

Note that visual information similar to the visual information depicted in each of FIGS. 25 and 26 may be displayed for a space available for parking even in a case of perpendicular parking of the vehicle 1, or a case of parking in a parking lot having a mark line indicating a parking position.

### <Left-Turn Assistance Process>

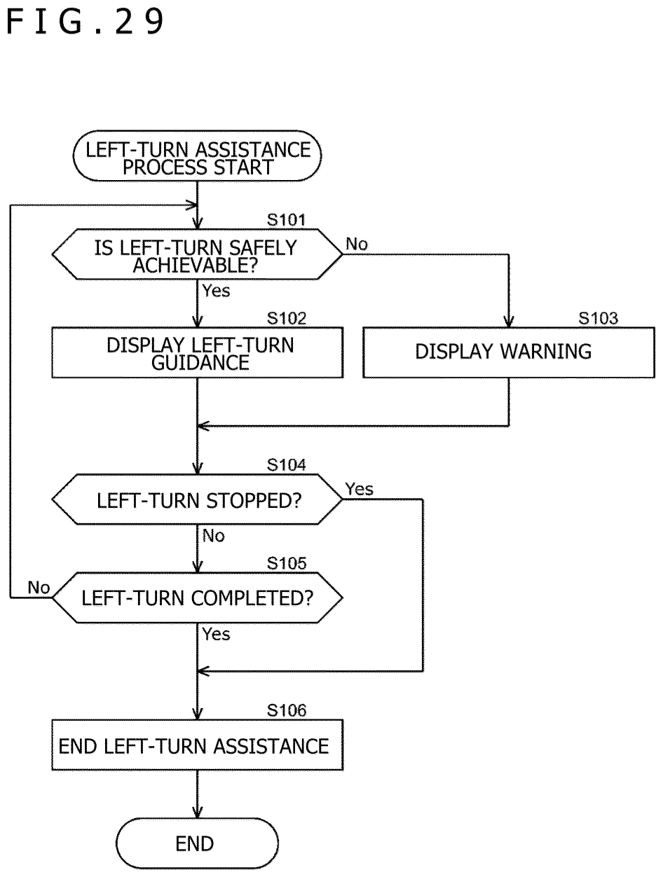

Described with reference to a flowchart in FIG. 29 next will be a left-turn assistance process executed by the vehicle 1.

For example, this process starts in a case where the recognition unit 73 has recognized that the vehicle 1 is to make a left-turn at a right-side driving intersection.

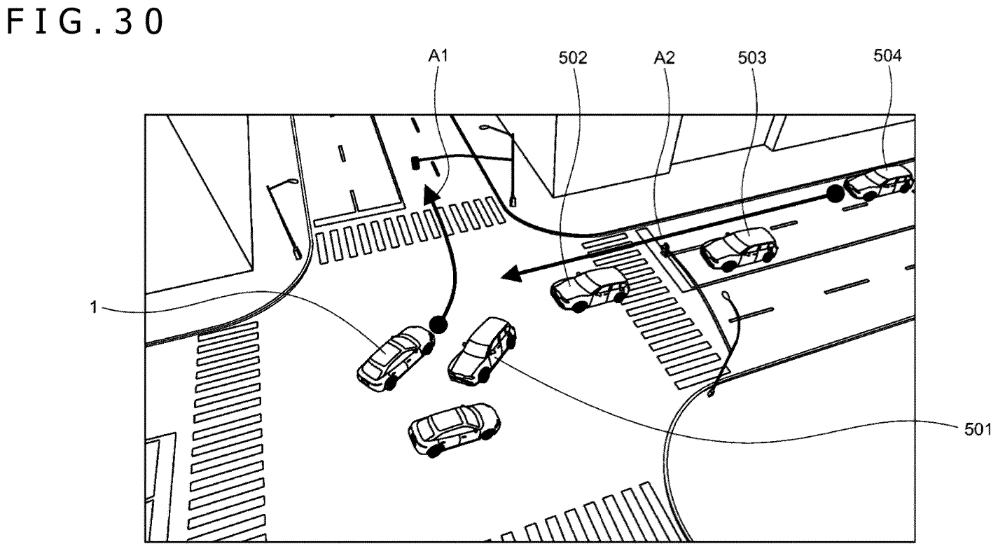

The left-turn assistance process in FIG. 29 will be hereinafter described while appropriately presenting an example of a case where the vehicle 1 makes a left-turn in a direction of an arrow A1 at a right-side driving intersection of a road which has two lanes for each way as depicted in FIG. 30, for example. In this example, a vehicle 501 is making a left-turn within the intersection on a center side lane of an opposite lane, while each of vehicles 502 and 503 intends to make a left-turn subsequently to the vehicle 501. Moreover, a vehicle 504 intends to travel straight at the intersection in a direction of an arrow A2 on an end side lane of the opposite lane.

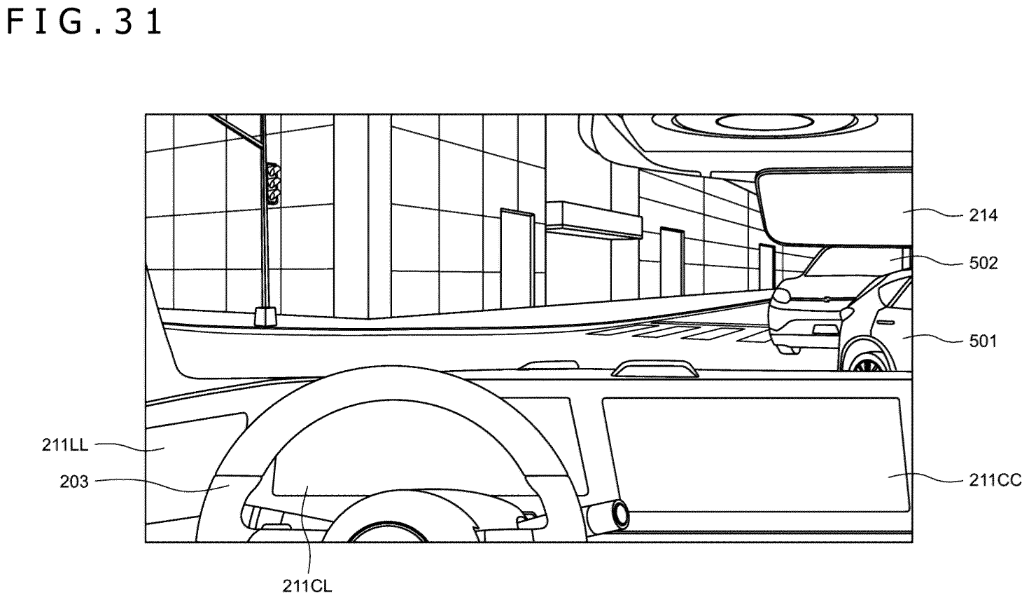

FIG. 31 depicts an example of a front visual field as viewed from the driver's seat 201 of the vehicle 1 in the state depicted in FIG. 30. As apparent from the figure, there is such a case where the driver is unable to visually recognize the vehicle 504 having entered a blind spot as viewed from the driver.

Meanwhile, in a case where the vehicle 504 is present in any one of the sensing region 102F of the radar 52 for a short distance, the sensing region 103F of the camera 51, the sensing region 104F of the LiDAR 53, and the sensing region 105F of the radar 52 for a long distance depicted in FIG. 2, the recognition unit 73 can detect the vehicle 504 even without recognition of the vehicle 504 by the driver.

In step S101, the recognition unit 73 determines whether or not a left-turn is safely achievable. For example, on the basis of sensor data received from the outside recognition sensor 25, the recognition unit 73 executes a detection process for detecting an approaching vehicle located on the opposite lane and crossed by the vehicle 1 for making a left-turn at the intersection. For example, in a case of continuous detection of a situation where no approaching vehicle possibly coming into a collision or contact with the vehicle 1 is present for a predetermined time (e.g., five seconds) on the basis of a relative position, a relative speed, and a traveling direction of a vehicle on the opposite lane, the recognition unit 73 determines that a safe left-turn is achievable. In this case, the process proceeds to step S102.

In step S102, the output unit 154 displays left-turn guidance under control by the output control unit 153.

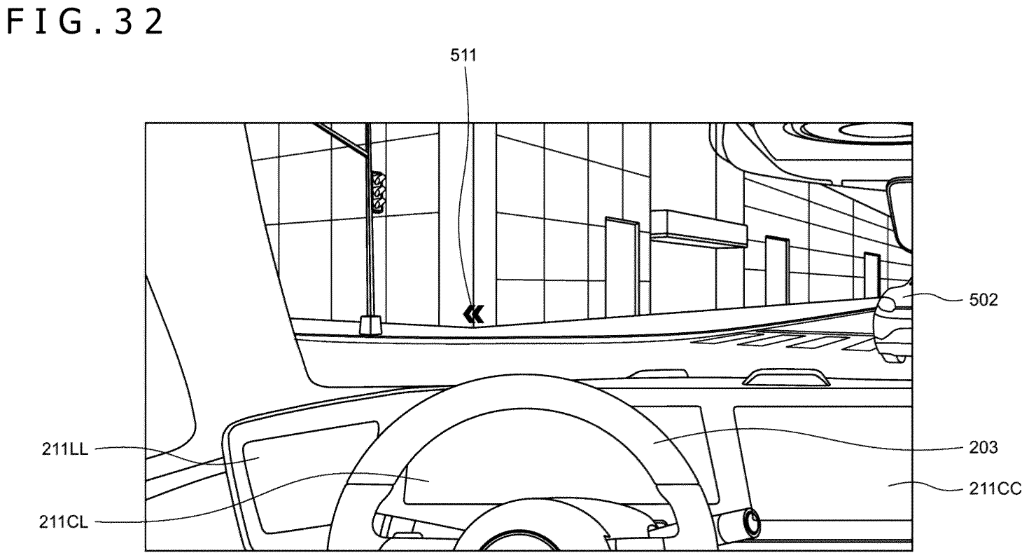

FIG. 32 depicts an example of guidance display superimposed within a visual field of the driver in front of the driver's seat 201 by using the HUD display 213.

For example, visual information 511 is displayed at a location slightly shifted toward the left from the center of the driver, below an eye line of the driver, and above a lower end of the windshield 204 by a predetermined height. The visual information 511 contains a leftward dual arrow indicating a traveling direction of the vehicle 1. A color for displaying for the visual information 511 is set to a color implicating that the vehicle 1 can safely make a left-turn (e.g., semitransparent green).

For example, the center of the driver herein is a center axis of the driver sitting at a predetermined position of the driver's seat 201 and facing the front.

This manner of display allows the driver to recognize that a safe left-turn is achievable in the absence of approach of an approaching vehicle from the opposite lane, without blocking the visual field of the driver.

Thereafter, the process proceeds to step S104.

Meanwhile, for example, in a case of detection that an approaching vehicle possibly coming into a collision or contact with the vehicle 1 is present on the basis of a relative position, a relative speed, and a traveling direction of a vehicle on the opposite lane, the recognition unit 73 determines that a safe left-turn is difficult in step S101. In this case, the process proceeds to step S103.

In step S103, the output unit 154 displays warning under control by the output control unit 153.

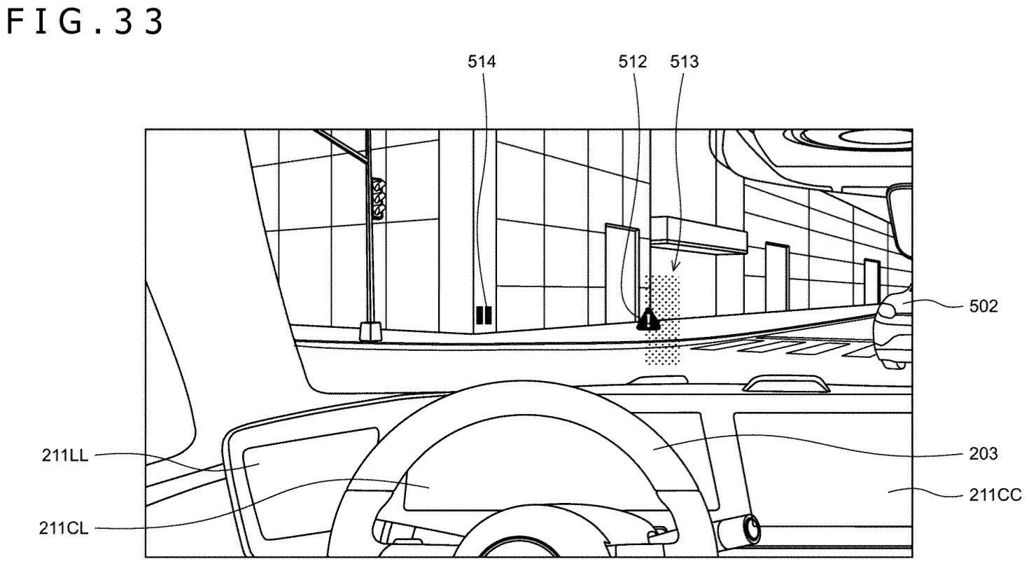

FIG. 33 depicts an example of warning display superimposed within the visual field of the driver in front of the driver's seat 201 by using the HUD display 213.

For example, visual information 512 indicating the presence of the approaching vehicle is displayed at a location slightly shifted toward the right (toward the approaching vehicle) from the center of the driver, below an eye line of the driving vehicle, and above the lower end of the windshield 204 by a predetermined height. The visual information 512 contains a triangular sign for an alert. For example, a color for displaying the sign is set to black for a symbol, and an alerting color (e.g., yellow) for a background.

Moreover, visual information 513 is displayed in the background of the visual information 512. While detailed illustrations are not given in this figure, the visual information 513 contains a semitransparent gradation region which has a color gradually changing to a darker color in a direction to the right from substantially the center of the visual information 512, for example. A color for displaying the visual information 513 is set to an alerting color (e.g., transparent yellow).

Furthermore, visual information 514 is displayed at the same position as the position of the visual information 511 in FIG. 32. The visual information 514 contains a double-line figure indicating a temporary stop. For example, a color for displaying the figure is set to an alerting color (e.g., semitransparent yellow).

This manner of display allows the driver to recognize that a safe left-turn is difficult due to approach of an approaching vehicle from the opposite lane and urges the driver to make a temporary stop, without blocking the visual field of the driver.

Thereafter, the process proceeds to step S104.

In step S104, the vehicle control unit 32 determines whether or not the left-turn has been stopped. In a case of determination that the left-turn has not been stopped, the process proceeds to step S105.

In step S105, the vehicle control unit 32 determines whether or not the left-turn has been completed. In a case of determination that the left-turn has not yet been completed, the process returns to step S101.

Thereafter, the processing from step S101 to step S105 is repeatedly executed until determination that the left-turn has been stopped in step S104, or determination that the left-turn has been completed in step S105.

In a case of determination that the left-turn is safely achievable in step S101 under the warning display in FIG. 32 after the repeated processing, for example, the warning display disappears, and the guidance display in FIG. 31 is presented. Meanwhile, in a case of determination that a safe left-turn is difficult in step S101 under the guidance display in FIG. 32, for example, the guidance display disappears, and the warning display in FIG. 33 is presented.

Meanwhile, in a case of determination that the left-turn has been stopped in step S104, or that the left-turn has been completed in step S105, the process proceeds to step S106.

In step S106, the output unit 154 ends the left-turn assistance under control by the output control unit 153. For example, the output unit 154 ends display of the visual information associated with left-turn assistance under control by the output control unit 153.

Thereafter, the left-turn assistance process ends.

In the manner described above, the driver achieves a safe left-turn of the vehicle 1.

For example, this process is also applicable to a case of a right-turn of the vehicle 1 at a left-side driving intersection. In this case, the positions and the directions of the respective items of visual information for the vehicle 1 for right-hand drive, for example, and the positions and the directions of the above examples are left-right symmetric.

Moreover, for example, vehicle-to-vehicle communication or road-to-vehicle communication may be employed for detection of a vehicle on an opposite lane.

### <Tollgate Passing Assistance Process>

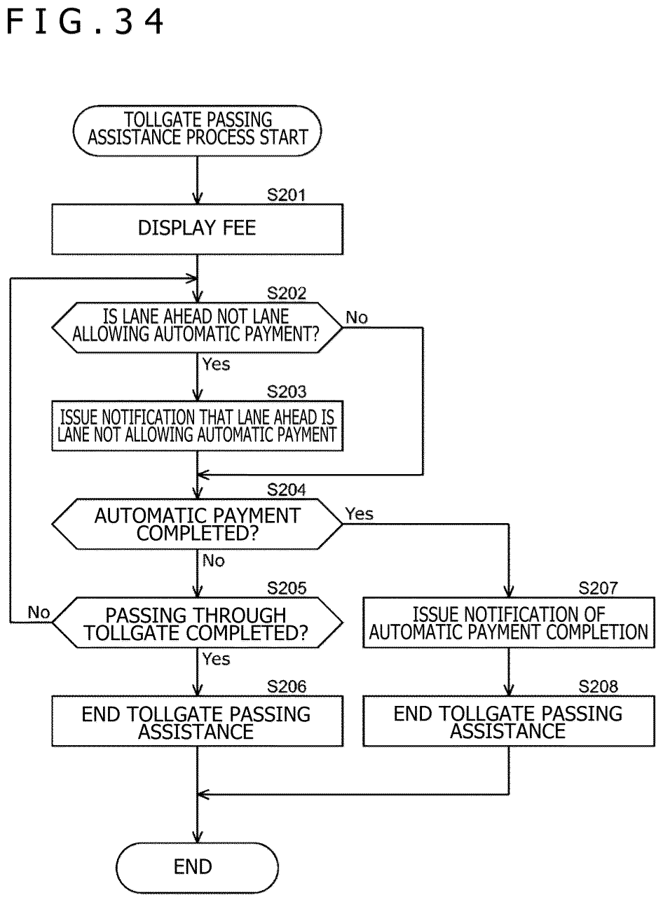

Described next with reference to FIGS. 34 to 37 will be a tollgate passing assistance process executed by the vehicle 1.

For example, this process starts in a case where the recognition unit 73 has recognized that the vehicle 1 has reached a predetermined distance range from a tollgate.

In step S201, the vehicle 1 displays a fee. For example, the recognition unit 73 recognizes a fee to be paid at the tollgate on the basis of information obtained by communication between the communication unit 22 and a system of the tollgate, map information accumulated in the map information accumulation unit 23, or the like. The output unit 154 displays the recognized fee under control by the output control unit 153.

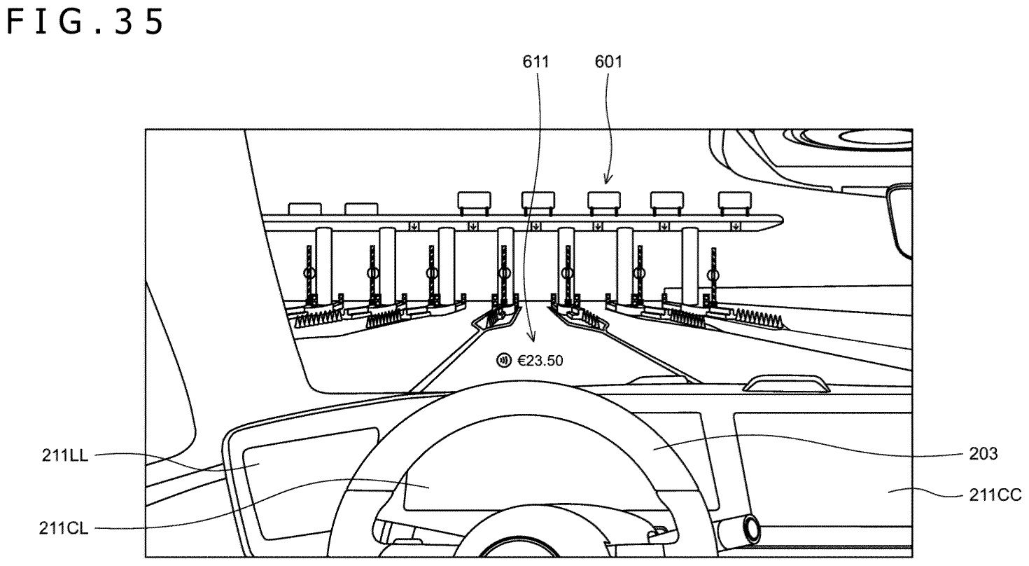

For example, as depicted in FIG. 35, the HUD display 213 superimposes visual information 611 within a visual field of the driver in front of the driver's seat 201. The visual information 611 is displayed at the center of the driver, below an eye line of the driving vehicle, and above the lower end of the windshield 204 by a predetermined height. The visual information 611 indicates a fee required to be paid at the tollgate. Moreover, an icon having a predetermined color (e.g., yellow) and indicating that the fee is not paid yet is displayed on the left side of the fee.

In addition, for example, it is assumed that the driver is allowed to drive with the hands off from a steering wheel 203 at an autonomous driving level of 2+. However, it is assumed that the driver is required to grip the steering wheel 203 before passing through the tollgate even at the autonomous driving level of 2+.

Meanwhile, while the vehicle 1 is running at the autonomous driving level of 2+, the output unit 154 may issue an alert that a grip of the steering wheel 203 is required to the driver under control by the output control unit 153 before display of the fee, simultaneously with display of the fee, or after display of the fee. This alert is executed with use of at least either visual information or auditory information.

In step S202, the recognition unit 73 determines whether or not a lane located ahead is a lane not allowing automatic payment. For example, the recognition unit 73 determines whether or not the lane located ahead (the lane on which the vehicle 1 is currently driving) is a lane not allowing automatic payment on the basis of information obtained by communication between the communication unit 22 and the system of the tollgate, image data supplied from the camera 51, or the like. In a case of determination that the lane located ahead is a lane not allowing automatic payment, the process proceeds to step S203.

In step S203, the output unit 154 issues a notification that the lane located ahead is a lane not allowing automatic payment under control by the output control unit 153.

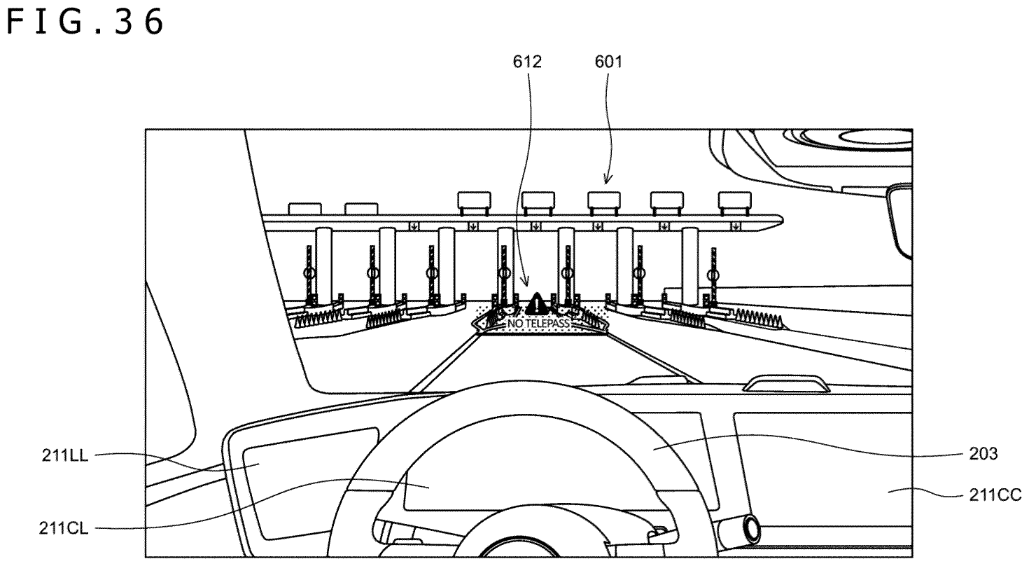

For example, as depicted in FIG. 36, the HUD display 213 superimposes visual information 612 within a visual field of the driver in front of the driver's seat 201. The visual information 612 is displayed in alignment with the position of the lane of the tollgate located ahead of the vehicle 1. The visual information 612 displays a triangular sign for an alert, and a message saying that this lane is a lane not allowing automatic payment. These sign and message are vertically displayed. Moreover, an underline is displayed below the message, and a semitransparent region is displayed in a background of the message. For example, a color for displaying the sign is set to black for a symbol, and an alerting color (e.g., semitransparent yellow) for a background. Each of the message, each color for displaying the underline, and the semitransparent region in the background is set to an alerting color (e.g., yellow).

This manner of display enables the driver to recognize that the lane located ahead of the vehicle 1 for entrance is a lane not allowing automatic payment, and change to a lane allowing automatic payment as necessary.

Thereafter, the process proceeds to step S204.

Meanwhile, in a case of determination that the lane located ahead is a lane allowing automatic payment in step S202, the process proceeds to step S204 while skipping the processing in step S203.

In step S204, the vehicle control ECU 21 determines whether or not automatic payment has been completed. In a case of determination that automatic payment has not been completed, the process returns to step S205.

In step S205, the recognition unit 73 determines whether or not passing through the tollgate has been completed. For example, in a case where the recognition unit 73 determines that passing through the tollgate has not yet been completed on the basis of image data supplied from the camera 51 or the like, the process returns to step S202.

Thereafter, the processing from step S202 to step S205 is repeatedly executed until determination that automatic payment has been completed in step S204, or determination that passing through the tollgate has been completed in step S205.

Meanwhile, in a case of determination that passing through the tollgate has been completed in step S205, the process proceeds to step S206. For example, this case corresponds to such a situation where passing through the tollgate has been completed by direct payment of the fee at the gate without use of automatic payment.

Note that the visual information 612 depicted in FIG. 36 in this case disappears when the vehicle 1 enters a gate not allowing automatic payment, for example.

In step S206, the output unit 154 ends the tollgate passing assistance under control by the output control unit 153.

Thereafter, the tollgate passing assistance process ends.

Meanwhile, in a case where the vehicle control ECU 21 in step S204 determines that automatic payment has been completed on the basis of communication with the system of the tollgate via the communication unit 22, for example, the process proceeds to step S207.

In step S207, the output unit 154 issues a notification that automatic payment has been completed under control by the output control unit 153.

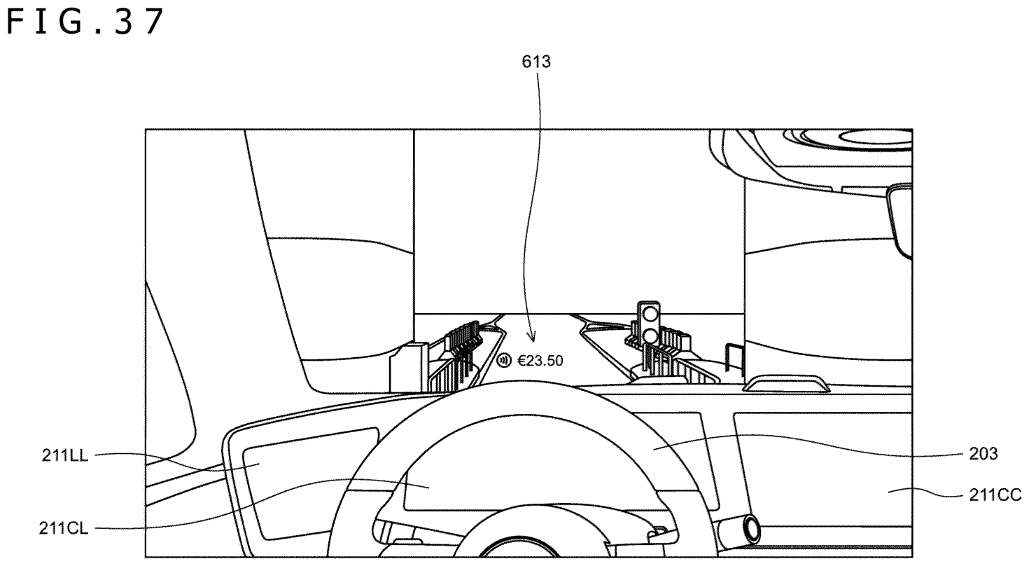

For example, as depicted in FIG. 37, the HUD display 213 superimposes visual information 613 within a visual field of the driver in front of the driver's seat 201. The visual information 613 has substantially the similar items of information to those contained in the visual information 611 in FIG. 35, and is displayed at the same position as the position of the visual information 611. However, unlike the visual information 611, the visual information 613 includes display of an icon having a predetermined color indicating that the fee has been already paid (e.g., green) on the left side of the fee. For example, the visual information 613 is displayed for a predetermined time, and then deleted.

In step S208, the output unit 154 ends the tollgate passing assistance under control by the output control unit 153.

Thereafter, the tollgate passing assistance process ends.

This manner of display enables the driver to recognize a fee to be paid at the tollgate beforehand. This manner of display also enables the driver to easily recognize a lane allowing automatic payment and a lane not allowing automatic lane, and select an appropriate lane.

In addition, in a case where the vehicle 1 is drivable at the autonomous driving level of 2+, for example, the output unit 154 may urge the driver to adopt the autonomous driving level of 2+ with use of at least either visual information or auditory information under control by the output control unit 153 after passing through the tollgate.

### <Roundabout Driving Assistance Process>

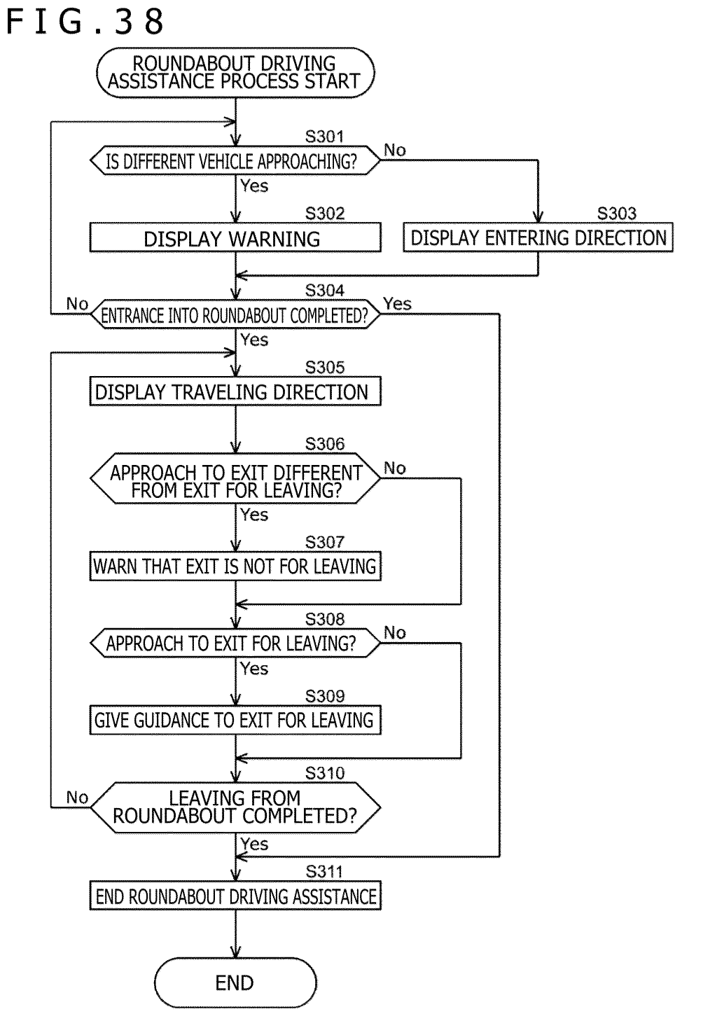

Described next with reference to a flowchart in FIG. 38 will be a roundabout driving assistance process executed by the vehicle 1.

For example, this process starts when the recognition unit 73 predicts entrance of the vehicle 1 into a roundabout (rotary).

Note that a method for enabling the recognition unit 73 to predict entrance of the vehicle 1 into the roundabout is not limited to a specific method. For example, the recognition unit 73 recognizes an entrance of the roundabout on the basis of at least any one of sensor data received from the outside recognition sensor 25, a current position of the vehicle 1, and map information accumulated in the map information accumulation unit 23. Thereafter, the recognition unit 73 predicts entrance of the vehicle 1 into the roundabout at the time of recognition of a stop line at the entrance of the roundabout, a stop before the stop line at the entrance of the roundabout, or operation of a turn signal in an entering direction for entering the roundabout near the entrance of the roundabout, for example.

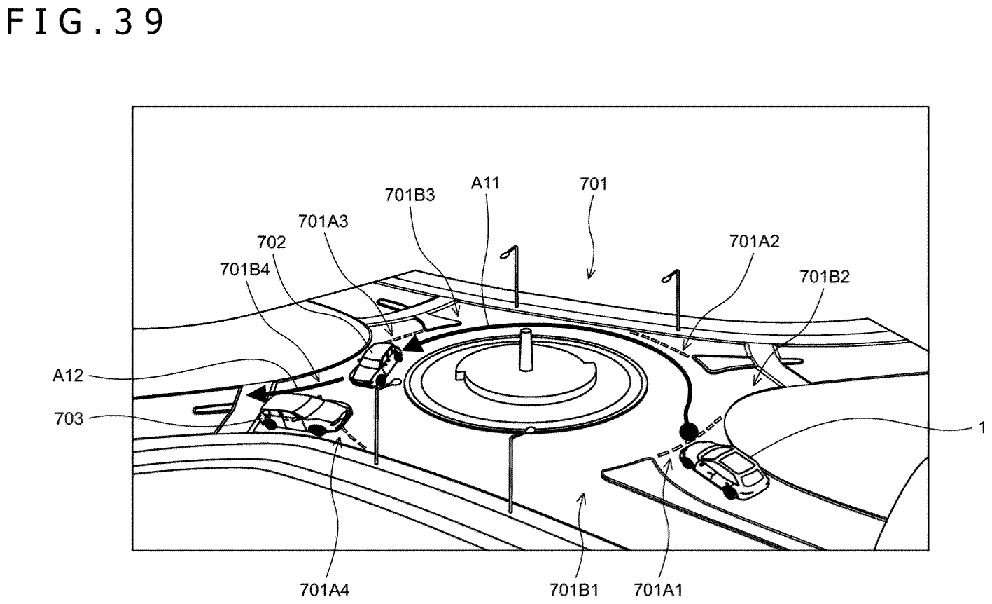

Described hereinafter will be an example of a case where the vehicle 1 enters a roundabout 701 from an entrance 701A1, advances counterclockwise in a direction of an arrow A11, and then leaves the roundabout 701 from an exit 701B4 as depicted in FIG. 39, for example. The roundabout 701 has the entrance 701A1, an exit 701B2, an entrance 701A2, an exit 701B3, an entrance 701A3, the exit 701B4, an entrance 701A4, and an exit 701B1 counterclockwise in this order.

Note that a vehicle 702 is traveling between the entrance 701A3 and the exit 701B4, and that a vehicle 703 is waiting in front of the entrance 701A4 in the state in FIG. 39.

In step S301, the recognition unit 73 determines whether or not a different vehicle is approaching on the basis of sensor data received from the outside recognition sensor 25 or others. In a case of determination that a different vehicle is approaching, the process returns to step S302.

In step S302, the output unit 154 displays warning under control by the output control unit 153. Specifically, warning is displayed before entrance into the roundabout 701.

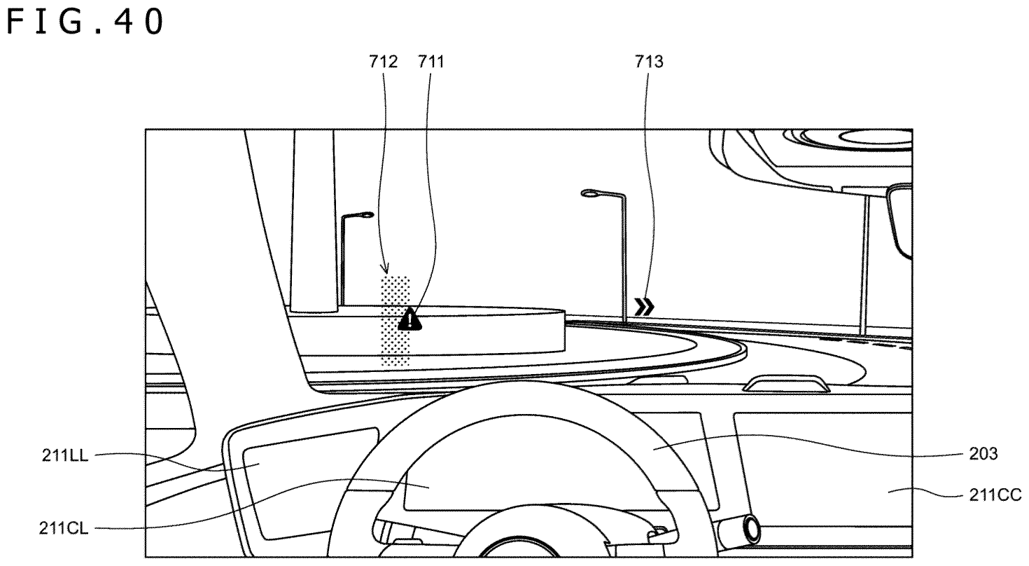

FIG. 40 depicts an example of warning display superimposed within a visual field of the driver in front of the driver's seat 201 by using the HUD display 213.

For example, visual information 711 is displayed at a location slightly shifted toward the left (toward the approaching vehicle) from the center of the driver, below an eye line of the driving vehicle, and above the lower end of the windshield 204 by a predetermined height. The visual information 711 contains a triangular sign for an alert. For example, a color for displaying the sign is set to black for a symbol, and an alerting color (e.g., yellow) for a background.

Moreover, visual information 712 is displayed in the background of the visual information 711. While detailed illustrations are not given in this figure, the visual information 712 contains a semitransparent gradation region which has a color gradually changing to a darker color in a direction to the left from substantially the center of the visual information 711. A color for displaying the visual information 712 is set to an alerting color (e.g., transparent yellow).

Moreover, visual information 713 is displayed at a location slightly shifted toward the right from the center of the driver, below an eye line of the driving vehicle, and above the lower end of the windshield 204 by a predetermined height. The visual information 711 contains a rightward dual arrow indicating a traveling direction at the roundabout 701, more specifically, a traveling direction into the roundabout 701. In this case, the vehicle 702 is approaching from the left, and entrance into the roundabout 701 is considered to be dangerous. Accordingly, a color for displaying the dual arrow is set to a color implicating a danger (e.g., semitransparent red).

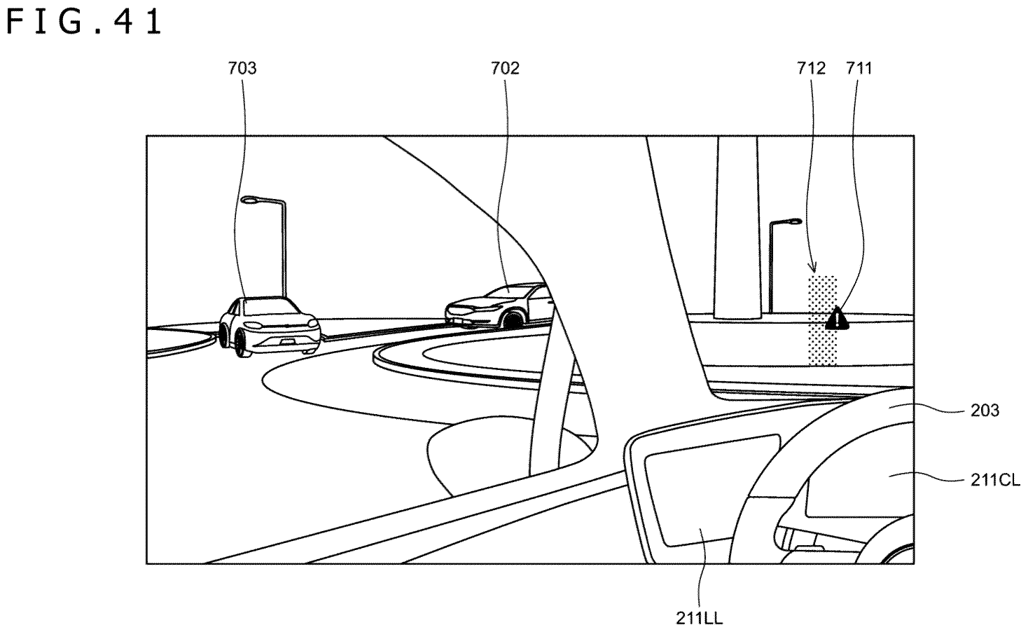

FIG. 41 depicts a state where a viewpoint is shifted toward a window of the driver's seat 201 from the state in FIG. 40. As apparent from the figure, the visual information 711 and the visual information 712 are disposed at such positions as to be visually recognizable simultaneously with attitude checking of the vehicles 702 and 703 through the window of the driver's seat 201.

This manner of display enables the driver to recognize a vehicle approaching from the left before entrance into the roundabout 701. This display further prevents a collision or contact between the approaching vehicle and the vehicle 1 driven by the driver into the roundabout 701 without noticing the approaching vehicle.

Note that the output unit 154 may output a warning sound as a notification of approach of a vehicle in an approaching direction of the vehicle with use of 360-degree real audio under control by the output control unit 153, for example.

Thereafter, the process proceeds to step S304.

Meanwhile, in a case of determination that no different vehicle is approaching in step S301, the process returns to step S303.

In step S303, the output unit 154 indicates an entering direction under control by the output control unit 153. For example, the HUD display 213 superimposes only the visual information 713 in FIG. 40 within a visual field of the driver in front of the driver's seat 201.

Thereafter, the process proceeds to step S304.

In step S304, the recognition unit 73 determines whether or not entrance into the roundabout 701 has been completed on the basis of sensor data received from the outside recognition sensor 25 or others. In a case of determination that entrance into the roundabout 701 has not yet been completed, the process returns to step S301.

Thereafter, the processing from step S301 to step S304 is repeatedly executed until determination that entrance into the roundabout 701 has been completed in step S304.

Meanwhile, in a case of determination that entrance into the roundabout 701 has been completed in step S304, the process proceeds to step S305.

In step S305, the output unit 154 displays a traveling direction under control by the output control unit 153.

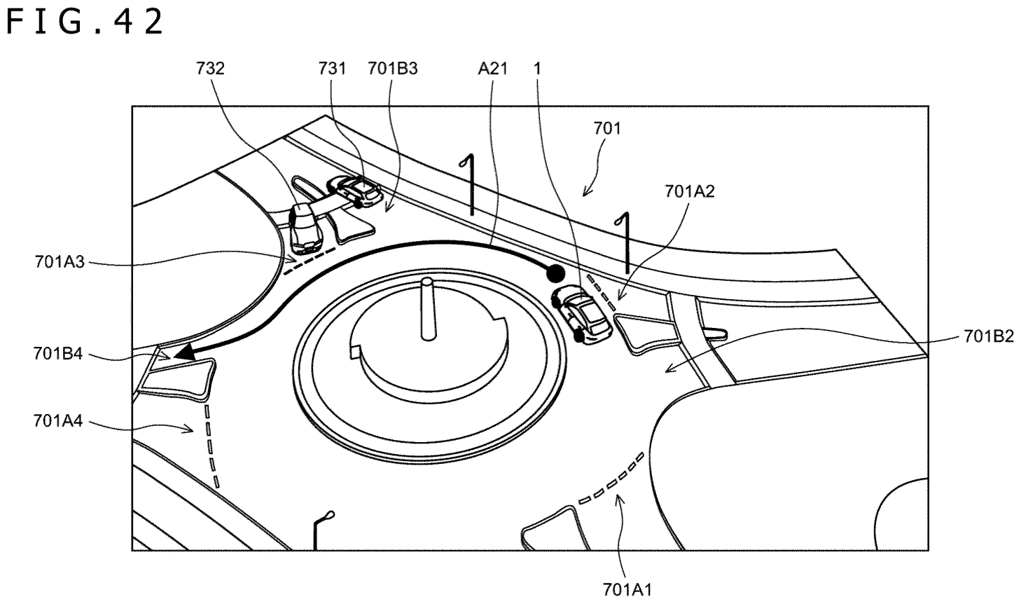

Described herein will be a display example of a traveling direction displayed on the vehicle 1 in a case of a state depicted in FIG. 42. In the state in FIG. 42, the vehicle 1 is traveling counterclockwise near the entrance 701A2 as indicated by an arrow A21. Moreover, a vehicle 731 leaves from the exit 701B3, while a vehicle 732 is waiting in front of the entrance 701A3.

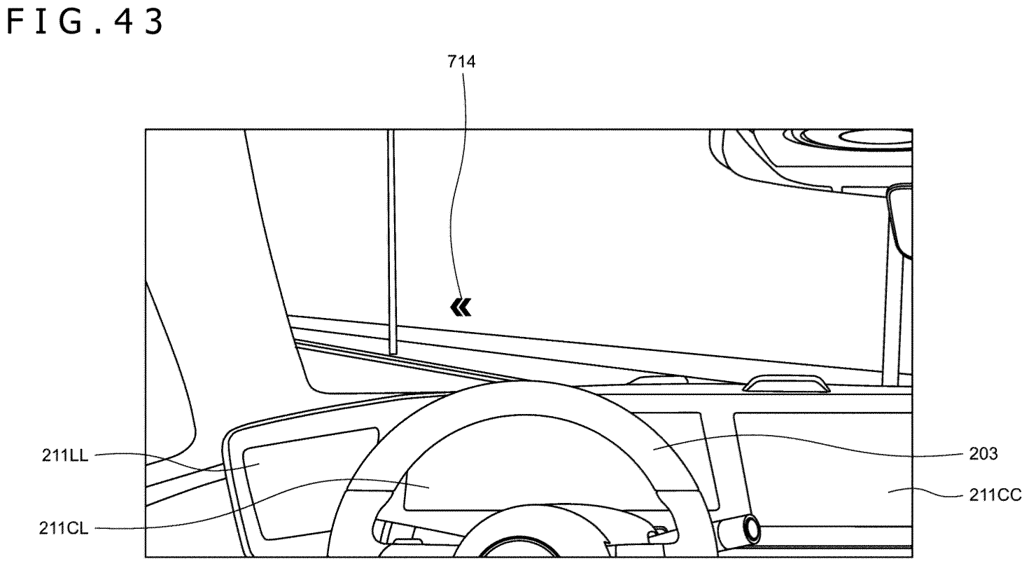

FIG. 43 depicts a display example of a traveling direction superimposed within a visual field of the driver in front of the driver's seat 201 by using the HUD display 213 in the state in FIG. 42.

For example, visual information 741 is displayed at a location slightly shifted toward the left (toward the traveling direction) from the center of the driver, below an eye line of the driving vehicle, and above the lower end of the windshield 204 by a predetermined height. The visual information 741 contains a leftward dual arrow indicating a traveling direction of the vehicle 1 and having a predetermined color (e.g., semitransparent green).

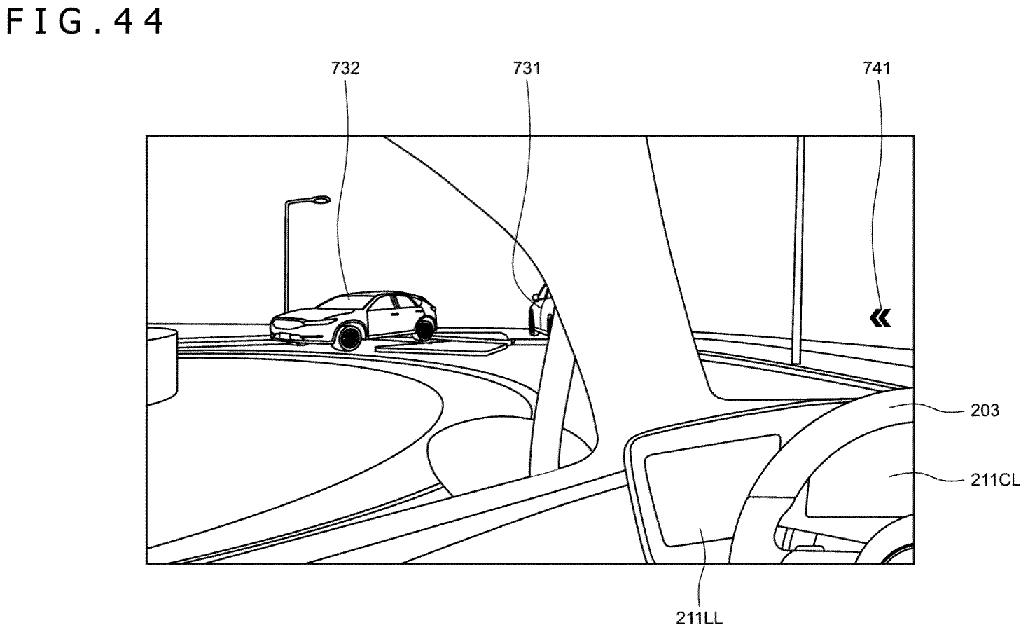

FIG. 44 depicts a state where a viewpoint is shifted toward a window of the driver's seat 201 from the state in FIG. 43. As apparent from the figure, the visual information 741 is disposed at such a position as to be visually recognizable simultaneously with attitude checking of the vehicles 731 and 732 through the window of the driver's seat 201. This manner of display enables the driver to check safety in the traveling direction while recognizing the traveling direction.

In step S306, the recognition unit 73 determines whether or not the vehicle 1 is approaching an exit different from the exit for leaving. For example, in a case of detection that an exit different from the exit for leaving is present within a display range of the HUD display 213 on the basis of sensor data received from the outside recognition sensor 25 or others, the recognition unit 73 determines that the vehicle 1 is approaching an exit different from the exit for leaving. In this case, the process proceeds to step S307.

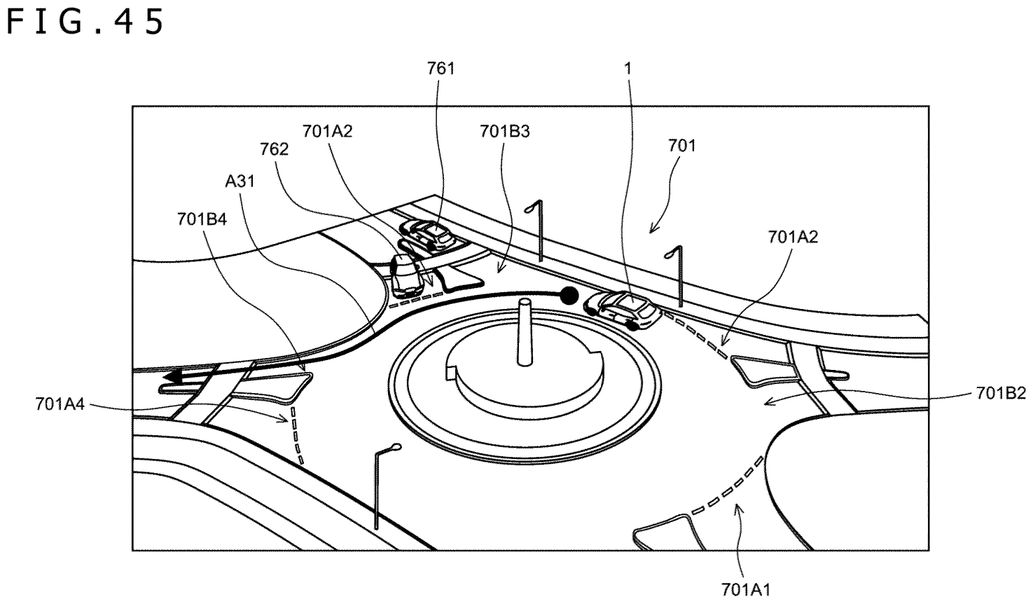

For example, in a case where the vehicle 1 traveling in a direction indicated by an arrow A31 to leave from the exit 701B4 approaches the exit 701B3 as depicted in FIG. 45, it is determined that the vehicle 1 has approached the exit different from the exit for leaving.

Note that a vehicle 761 has left from the exit 701B3, and that a vehicle 762 is waiting in front of the entrance 701A3 in the state of FIG. 45.

In step S307, the output unit 154 warns that the current exit is not the exit for leaving under control by the output control unit 153.

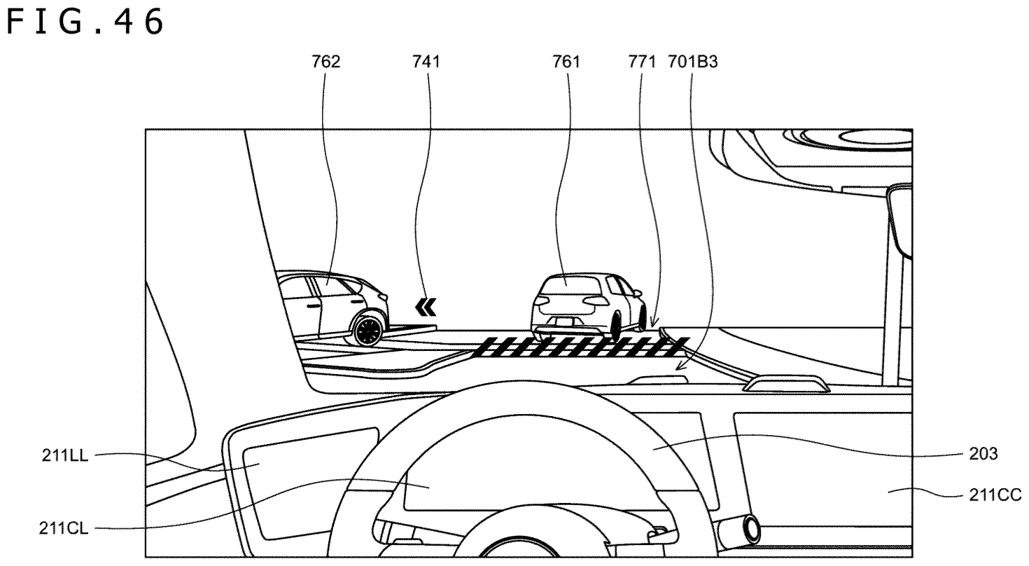

FIG. 46 depicts a display example of warning display superimposed within a visual field of the driver in front of the driver's seat 201 by using the HUD display 213 in the state in FIG. 45. In this example, visual information 771 is displayed in addition to the visual information 741 which is similar to the visual information 741 depicted in FIG. 43.

The visual information 771 contains stripes of diagonal lines displayed in alignment with the position of the exit 701B3. A color for displaying the strips is set to an alerting color (e.g., transparent yellow).

In addition, in a case where the visual information 771 is displayed on an outer circumference of the roundabout 701 at the exit 701B3, for example, there is a possibility that the driver erroneously recognizes an annular road within the roundabout 701 as a road not allowed to enter. However, for example, the visual information 771 is superimposed, within the visual field of the driver, on a road surface extending toward the outside of the roundabout 701 from the exit 701B3 outside the outer circumference of the roundabout 701. For example, the visual information 771 is displayed in alignment with the position of a crosswalk disposed outside the outer circumference of the roundabout 701 near the exit 701B3.

In addition, a display position of the visual information 771 relative to the exit 701B3 is fixed. Accordingly, the display position of the visual information 771 moves according to movement of the position of the exit 701B3 following movement of the vehicle 1 and viewed through the HUD display 213.

This manner of display prevents use of a different exit by the driver of the vehicle 1 for leaving.

Thereafter, the process proceeds to step S308.

Meanwhile, in a case of detection that an exit different from the exit for leaving is absent within the display range of the HUD display 213 on the basis of sensor data received from the outside recognition sensor 25 or others, for example, the recognition unit 73 in step S306 determines that the vehicle 1 is not approaching an exit different from the exit for leaving. In this case, the process proceeds to step S308 while skipping the processing in step S307.

In step S308, the recognition unit 73 determines whether or not the vehicle 1 is approaching the exit for leaving. For example, in a case of detection that the exit for leaving is present within the display range of the HUD display 213 on the basis of sensor data received from the outside recognition sensor 25 or others, the recognition unit 73 determines that the vehicle 1 is approaching the exit for leaving. In this case, the process proceeds to step S309.

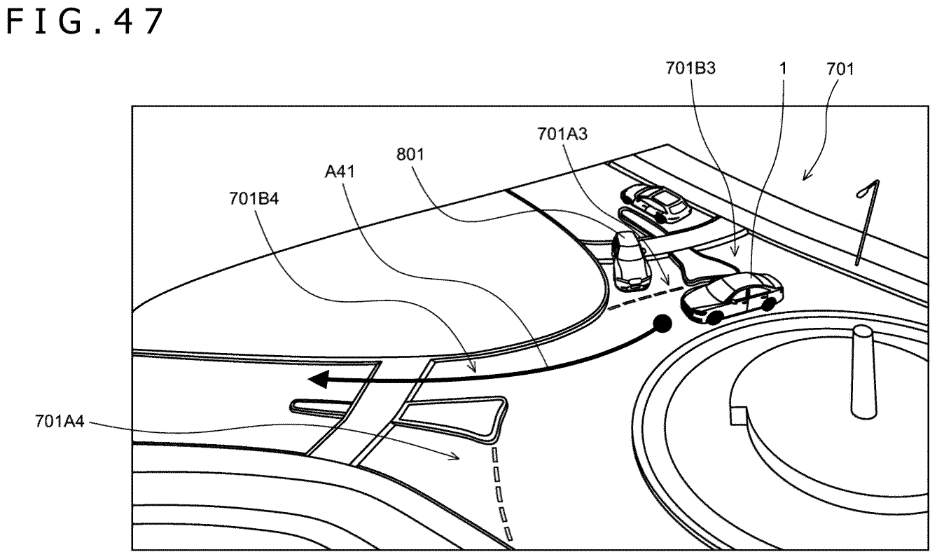

For example, in a case where the vehicle 1 traveling in a direction indicated by an arrow A41 to leave from the exit 701B4 approaches the exit 701B4 as depicted in FIG. 47, it is determined that the vehicle 1 has approached the exit for leaving.

Note that a vehicle 801 is waiting at the entrance 701A3, and that a vehicle 802 is leaving from the exit 701B3 in the state in FIG. 47.

In step S309, the output unit 154 gives guidance to the exit for leaving under control by the output control unit 153.

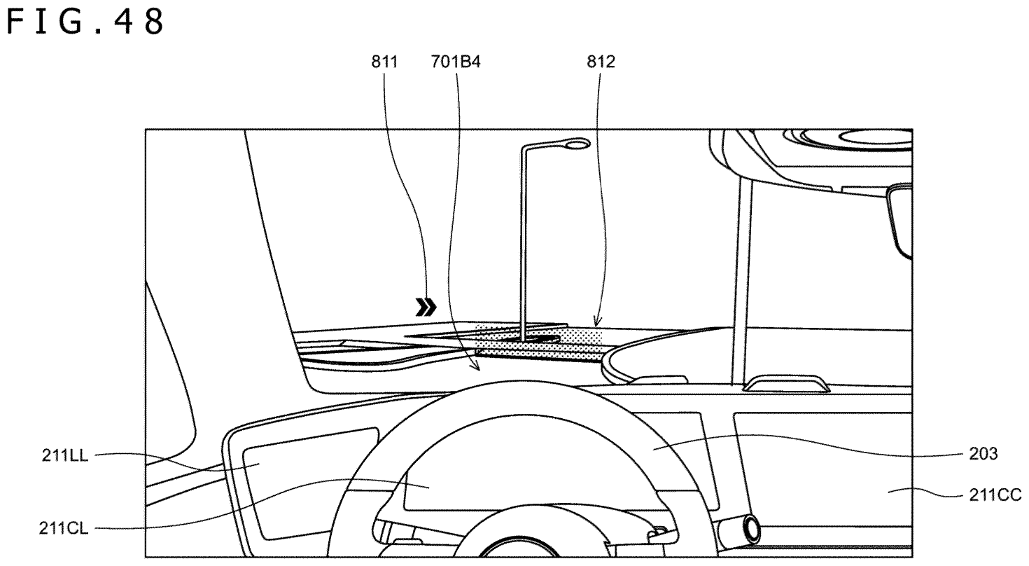

An example of guidance display of the exit for leaving will be described herein with reference to FIGS. 48 to 59.

FIG. 48 depicts a first example of guidance display superimposed within a visual field of the driver in front of the driver's seat 201 to give guidance to the exit for leaving by using the HUD display 213 in the state in FIG. 47. In this example, visual information 811 and visual information 812 are displayed.

The visual information 811 is displayed at the similar position to the position of the visual information 741 in FIG. 43. In this case, however, the traveling direction of the vehicle 1 is the opposite direction. Accordingly, the visual information 811 contains a rightward dual arrow indicating a traveling direction opposite to the direction of the visual information 741 and having a predetermined color (e.g., semitransparent green).

While detailed illustrations are not given in this figure, the visual information 812 contains a line indicating the position of the exit 701B4 from which the vehicle 1 leaves, and a gradation region which has a color gradually changing to a lighter color above this line. A color for displaying the line is set to a color implicating that the exit corresponds to the exit for leaving (e.g., green). A color for displaying the gradation region is set to a color implicating that the exit corresponds to the exit for leaving (e.g., semitransparent green).

For example, the visual information 812 is displayed at a position similar to the position of the visual information 771 in FIG. 46 with respect to the exit 701B4. Specifically, the visual information 812 is superimposed, within a visual field of the driver, on a road surface extending toward the outside of the roundabout 701 from the exit 701B4 outside the outer circumference of the roundabout 701.

In addition, a display position of the visual information 812 relative to the exit 701B4 is fixed. Accordingly, the display position of the visual information 812 moves according to movement of the position of the exit 701B4 following movement of the vehicle 1 and viewed through the HUD display 213.

For example, the visual information 811 and the visual information 812 disappear when the vehicle 1 moves to such a position where the visual information 812, which is located at the fixed display position relative to the exit 701B4, is invisible.

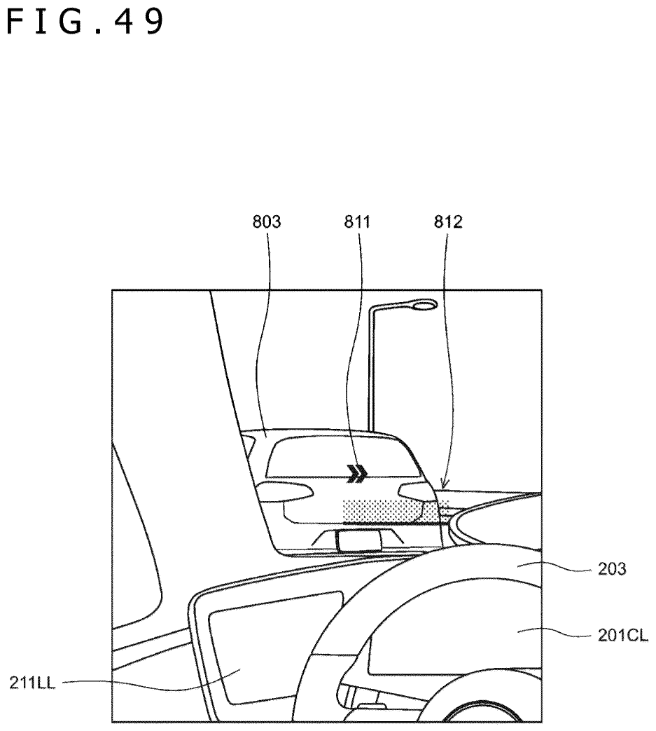

Each of FIGS. 49 to 51 depicts an example of a case where a preceding vehicle 803 is present in display regions of the visual information 811 and the visual information 812.

For example, in the case of the example in FIG. 49, the visual information 811 and the visual information 812 are superimposed on the vehicle 803 and displayed thereon without change. Note that a display mode (e.g., color) of a portion included in the visual information 812 and overlapping with the vehicle 803 may be changed, for example.

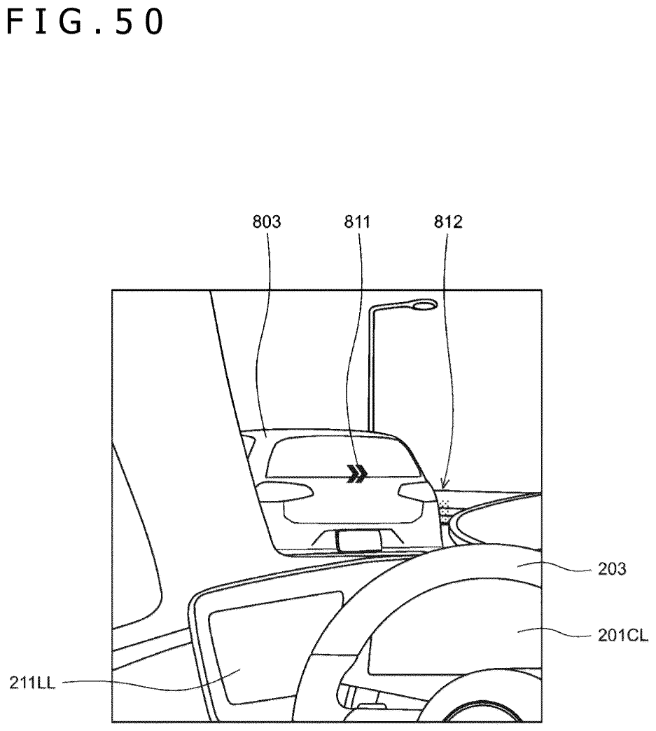

In the case of the example in FIG. 50, for example, the visual information 811 is superimposed on the vehicle 803 and displayed thereon. As for the visual information 812, however, display of the portion overlapping with the vehicle 803 disappears.

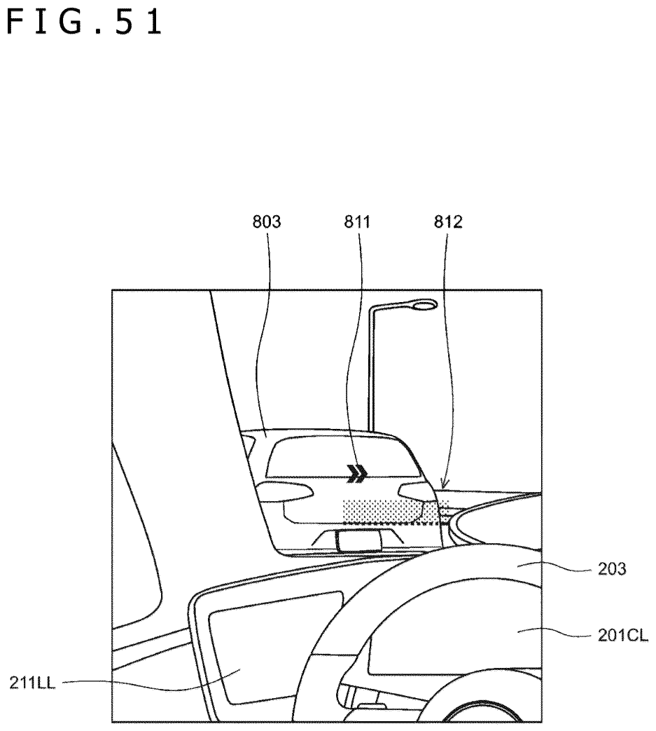

In the case of the example in FIG. 51, for example, the visual information 811 is superimposed on the vehicle 803 and displayed thereon. As for the visual information 812, however, a line of the portion overlapping with the vehicle 803 is a dotted line.

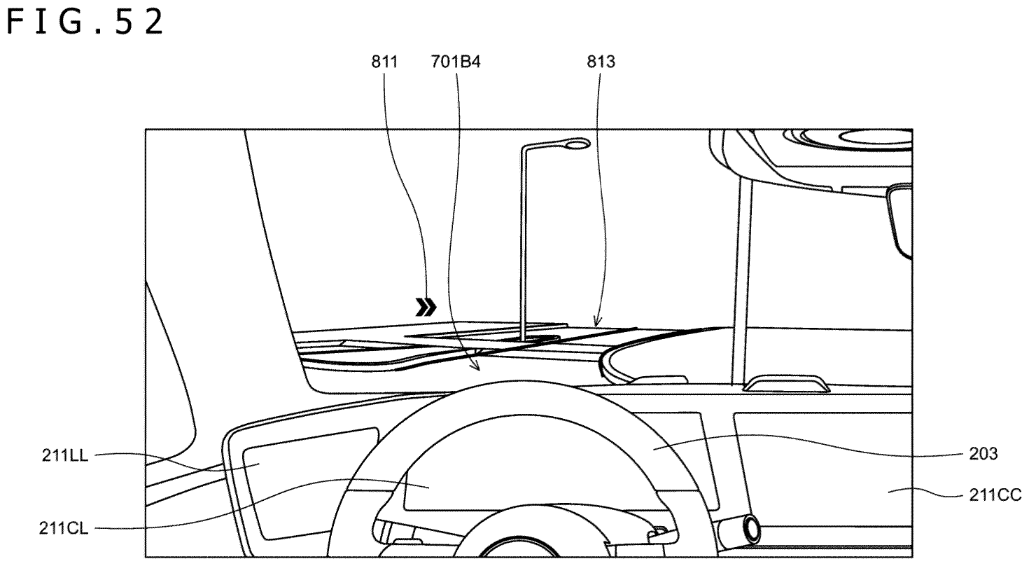

FIG. 52 depicts a second example of guidance display superimposed within a visual field of the driver in front of the driver's seat 201 to give guidance to the exit for leaving by using the HUD display 213 in the state in FIG. 47. In comparison with the example in FIG. 48, the visual information 811 in the example of FIG. 52 is displayed in a similar manner, while visual information 813 is displayed instead of the visual information 812.

The visual information 813 contains auxiliary lines extending along both ends of a road extending to the outside of the roundabout 701 from the exit 703B3. A color for displaying the auxiliary lines is set to a color implicating that the exit corresponds to the exit for leaving (e.g., green).

For example, the visual information 811 and the visual information 813 disappear when the vehicle 1 leaves from the exit 701B4 and advances to a predetermined position, such as at the time when the vehicle 1 has crossed a crosswalk of the exit 701B4. At this time, the visual information 811 and the visual information 813 may fade out, for example.

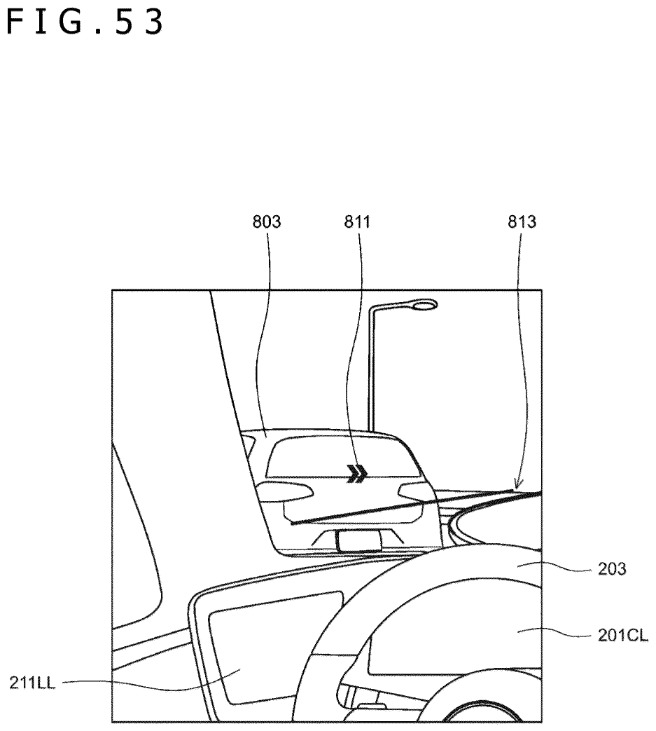

Each of FIGS. 53 to 55 depicts an example of a case where the preceding vehicle 803 is present in display regions of the visual information 811 and the visual information 813.

In the case of the example in FIG. 53, for example, the visual information 811 and the visual information 813 are superimposed on the vehicle 803 and displayed thereon without change. Note that a display mode (e.g., color) of a portion included in the visual information 813 and overlapping with the vehicle 803 may be changed.

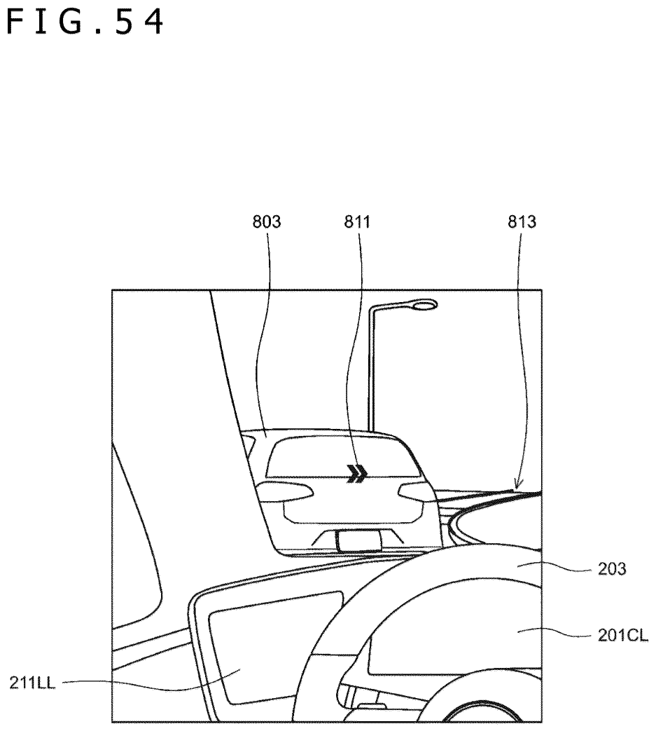

In the case of the example in FIG. 54, for example, the visual information 811 is superimposed on the vehicle 803 and displayed thereon. As for the visual information 813, however, display of the portion overlapping with the vehicle 803 disappears.

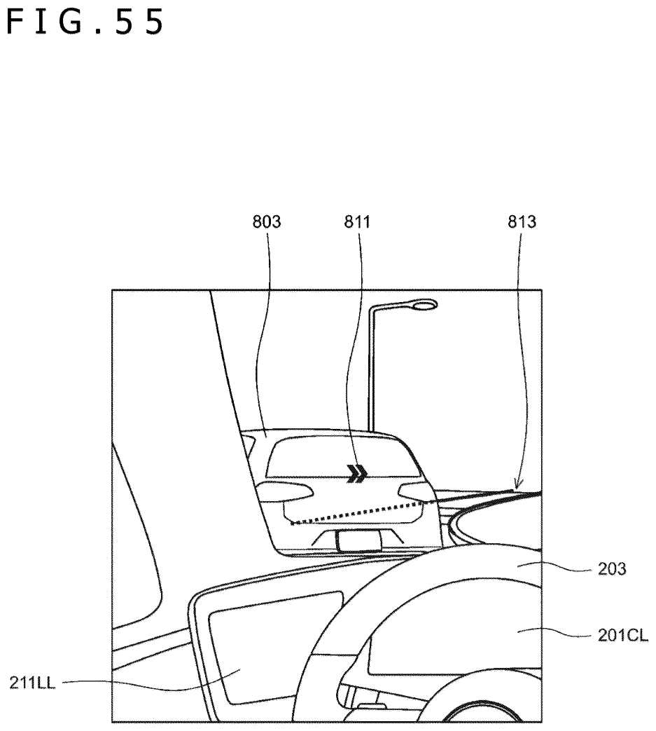

In the case of the example in FIG. 55, for example, the visual information 811 is superimposed on the vehicle 803 and displayed thereon. As for the visual information 813, however, the auxiliary line of the portion overlapping with the vehicle 803 is a dotted line.

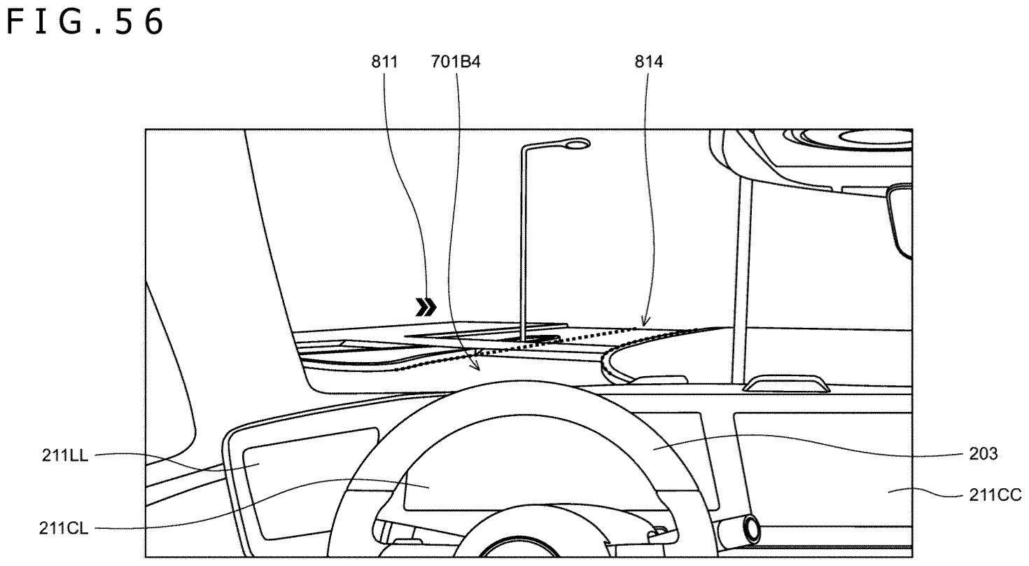

FIG. 56 depicts a third example of guidance display superimposed within a visual field of the driver in front of the driver's seat 201 to give guidance to the exit for leaving by using the HUD display 213 in the state in FIG. 47. In comparison with the example in FIG. 52, the visual information 811 in the example of FIG. 56 is displayed in a similar manner, while visual information 814 is displayed instead of the visual information 813.

The visual information 814 is different from the visual information 813 in FIG. 52 in that the auxiliary lines are dotted lines. A color for displaying the auxiliary lines is set to a color implicating that the exit corresponds to the exit for leaving (e.g., green).

For example, the visual information 811 and the visual information 814 disappear when the vehicle 1 leaves from the exit 701B4 and advances to a predetermined position, such as at the time when the vehicle 1 has crossed a crosswalk of the exit 701B4. At this time, the visual information 811 and the visual information 814 may fade out, for example.

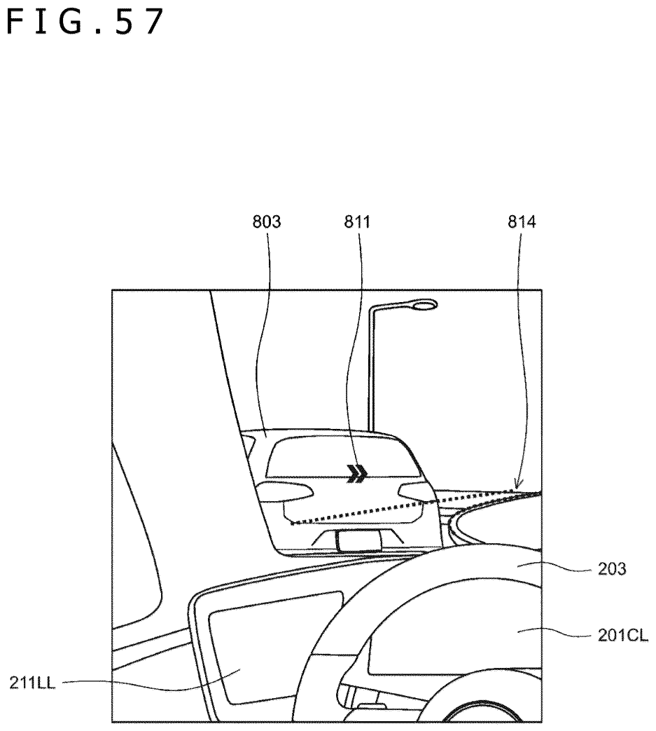

Each of FIGS. 57 to 59 depicts an example of a case where the preceding vehicle 803 is present in display regions of the visual information 811 and the visual information 814.

In the case of the example in FIG. 57, for example, the visual information 811 and the visual information 814 are superimposed on the vehicle 803 and displayed thereon without change. Note that a display mode (e.g., color) of a portion included in the visual information 814 and overlapping with the vehicle 803 may be changed, for example.

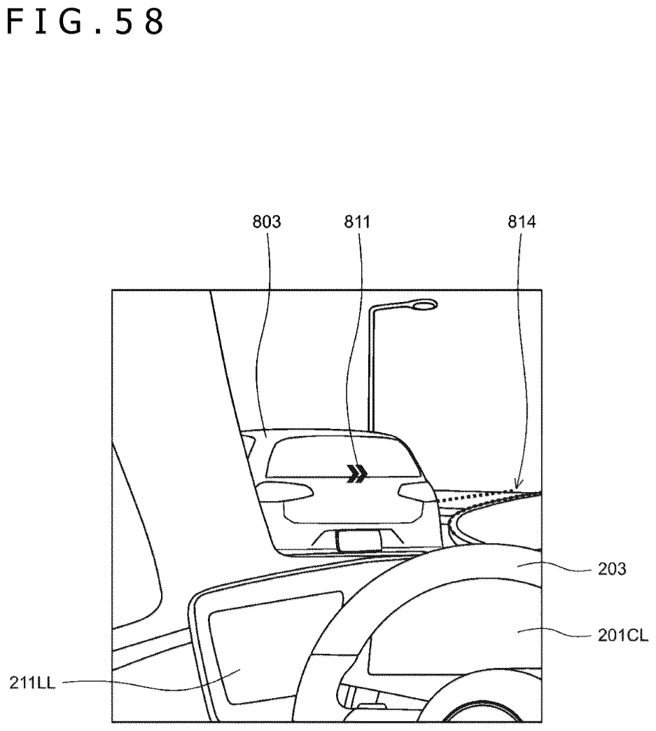

In the case of the example in FIG. 58, for example, the visual information 811 is superimposed on the vehicle 803 and displayed thereon. As for the visual information 814, however, display of the portion overlapping with the vehicle 803 disappears.

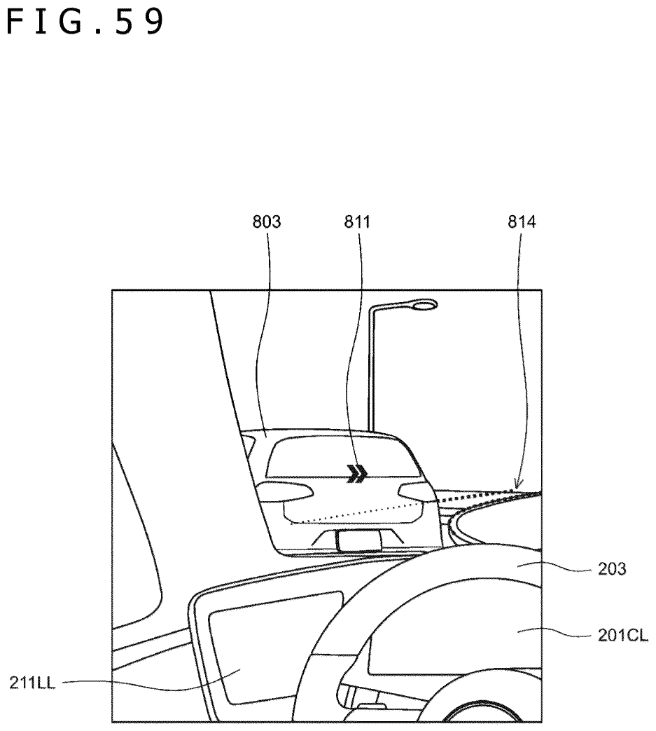

In the case of the example in FIG. 59, for example, the visual information 811 is superimposed on the vehicle 803 and displayed thereon. As for the visual information 814, however, the auxiliary line of the portion overlapping with the vehicle 803 has smaller dots.

This manner of display enables the driver to accurately recognize the exit for leaving, and drive the vehicle 1 to leave from the recognized exit.

Thereafter, the process proceeds to step S310.

Meanwhile, in a case of detection that the exit for leaving is absent within the display range of the HUD display 213 on the basis of sensor data received from the outside recognition sensor 25 or others, for example, the recognition unit 73 in step S308 determines that the vehicle 1 is not approaching the exit for leaving. In this case, the process proceeds to step S310 while skipping the processing in step S309.

In step S310, the recognition unit 73 determines whether or not leaving from the roundabout 701 has been completed on the basis of sensor data received from the outside recognition sensor 25 or others. In a case of determination that leaving from the roundabout 701 has not yet been completed, the process returns to step S305.

Thereafter, the processing from step S305 to step S310 is repeatedly executed until determination that leaving from the roundabout 701 has been completed in step S310.

Meanwhile, in a case of determination that leaving from the roundabout 701 has been completed in step S310, the process proceeds to step S311.

In step S311, the output unit 154 ends the roundabout driving assistance under control by the output control unit 153.

Thereafter, the roundabout driving assistance process ends.

The manner of display described above enables the driver to safely drive the vehicle 1 into the roundabout 701, safely travel within the roundabout 701, and leave from the desired exit.

For example, this process is also applicable to a case where the vehicle 1 travels at a clockwise roundabout. In this case, the positions and the directions of the respective items of visual information for the vehicle 1 for right-hand drive, for example, and the positions and the directions of the above examples are left-right symmetric.

In the manner described above, visual information associated with driving assistance according to driving operations is superimposed at least either within a visual field of the driver, or on a surrounding image indicating surroundings of the vehicle 1 and presented to the driver, on the basis of sensing results around the vehicle 1. Accordingly, appropriate driving assistance is achievable with reference to the visual information.

### 3. Modifications

Modifications of the embodiment according to the present technology described above will be hereinafter described.

Designs or the like of the visual information described above may be modified in appropriate manners.

Types of vehicles to which the present technology is applicable are not limited to specific types.

For example, the present technology is also applicable to moving bodies each including a windshield other than vehicles (e.g., motorbike etc.). Moreover, the present technology is also applicable to moving bodies each including a transparent component, such as a windshield, on which a display is providable within a visual field of a driver.

### 4. Others

### <Configuration Example of Computer>

A series of processes described above may be executed either by hardware or by software. In a case where the series of processes are executed by software, a program constituting this software is installed in a computer. Examples of this computer herein include a computer incorporated in dedicated hardware, a computer capable of executing various functions under various programs installed in the computer, such as a general-purpose personal computer, and the like.

FIG. 22 is a block diagram depicting a configuration example of hardware of a computer which executes the series of processes described above under a program.

A CPU (Central Processing Unit) 1001, a ROM (Read Only Memory) 1002, and a RAM (Random access Memory) 1003 included in a computer 1000 are connected to each other via a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, and others. The output unit 1007 includes a display, a speaker, and others. The storage unit 1008 includes a hard disk, a non-volatile memory, and others. The communication unit 1009 includes a network interface and others. The drive 1010 drives a removable medium 1011 such as a magnetic disk, an optical disk, a magneto-optical disk, and a semiconductor memory.

According to the computer 1000 configured as above, the CPU 1001 loads a program recorded in the storage unit 1008, for example, to the RAM 1003 via the input/output interface 1005 and the bus 1004, and executes the loaded program to perform the series of processes described above.

For example, the program executed by the computer 1000 (CPU 1001) may be recorded in the removable medium 1011 as a package medium or the like, and provided in this form. Alternatively, the program may be provided via a wired or wireless transfer medium, such as a local area network, the Internet, and digital satellite broadcasting.

According to the computer 1000, the program may be installed in the storage unit 1008 via the input/output interface 1005 from the removable medium 1011 attached to the drive 1010. Alternatively, the program may be received by the communication unit 1009 via a wired or wireless transfer medium, and installed in the storage unit 1008. Instead, the program may be installed beforehand in the ROM 1002 or the storage unit 1008.

Note that the program executed by the computer may be a program under which the processes are performed in time series in the orders explained in the present description, or may be a program under which the processes are performed in parallel, or at necessary timing such as an occasion of a call.

Moreover, the system in the present description refers to a set of a plurality of constituent elements (devices, modules (parts), etc.), and all the constituent elements are not required to be contained in an identical housing. Accordingly, a plurality of devices stored in separate housings and connected to each other via a network, and one device having a plurality of modules contained in one housing are both systems.

Furthermore, embodiments of the present technology are not limited to the embodiment described above, but may be modified in various manners without departing from the scope of the subject matters of the present technology.

For example, the present technology may be configured as cloud computing where one function is shared by a plurality of devices and performed by the devices in cooperation with each other via a network.

In addition, each of the steps described in the above flowcharts may be executed by one device, or may be shared and executed by a plurality of devices.

Besides, in a case where a plurality of processes are contained in one step, the plurality of processes contained in the one step may be executed by one device, or may be shared and executed by a plurality of devices.

### <Configuration Combination Examples>

The present technology may have following configurations.

(1)

An information processing device including:
an output control unit that superimposes visual information associated with driving assistance at least either within a visual field of a driver, or on a surrounding image indicating surroundings of a moving body and presented to the driver, the visual information being superimposed on the basis of at least any one of a sensing result around the moving body, information acquired from an outside, and information accumulated on the moving body.
   (2)

The information processing device according to (1) above, in which the output control unit superimposes, within the visual field of the driver, the visual information associated with driving assistance at a roundabout.

(3)

The information processing device according to (2) above, in which the output control unit superimposes, within the visual field of the driver, at least either first visual information that is the visual information indicating a first exit through which the moving body leaves from the roundabout, or second visual information that is the visual information associated with prevention of leaving through a second exit different from the first exit.

(4)

The information processing device according to (3) above, in which the second visual information is superimposed, within the visual field of the driver, on a road surface extending from the second exit to an outside of the roundabout outside an outer circumference of the roundabout.

(5)

The information processing device according to any one of (2) to (4) above, in which the output control unit superimposes, within the visual field of the driver, the visual information indicating a traveling direction of the moving body at the roundabout.

(6)

The information processing device according to (5) above, in which the visual information is superimposed, within the visual field of the driver, on a position shifted in the traveling direction from a center of the driver.

(7)

The information processing device according to any one of (2) to (4) above, in which, before entrance into the roundabout, the output control unit superimposes, within the visual field of the driver, the visual information indicating an alert against a different moving body approaching the moving body within the roundabout.

(8)

The information processing device according to (7) above, in which the visual information is superimposed, within the visual field of the driver, on a position shifted toward the different moving body from a center of the driver.

(9)

The information processing device according to (1) above, in which, in a case of parking of the moving body, the output control unit superimposes, on a back image that is the surrounding image at a back of the moving body, the visual information indicating at least either a position or a shape of an obstacle located at the back of the mobile body.

(10)

The information processing device according to (9) above, in which the output control unit changes a display mode of the visual information in a case where the obstacle is present at a position coming into a collision or contact with a back door of the moving body in a case of opening of the back door.

(11)

The information processing device according to (9) or (10) above, in which the visual information contains at least either a frame surrounding an outer circumference of at least a part of the obstacle, or rectangular cells arranged in a grid shape and superimposed on at least a part of the obstacle.

(12)

The information processing device according to (1) above, in which the output control unit superimposes the visual information indicating a space available for parking on the surrounding image, and changes a display mode of the visual information according to a size of the space.

(13)

The information processing device according to (1) above, in which the output control unit superimposes the visual information indicating a space available for parking on the surrounding image, and changes a display mode of the visual information in a case where the moving body is parked within the space.

(14)

The information processing device according to (1) above, in which the visual information that indicates a track of the moving body predicted on the basis of a state of the moving body during parking is superimposed on the surrounding image.

(15)

The information processing device according to (1) above, in which the output control unit superimposes, on the visual field of the driver, the visual information indicating whether or not a safe turn is achievable at an intersection on the basis of presence or absence of a different moving body approaching the intersection on an opposite lane in a case where the moving body turns at the intersection and crosses the opposite lane.

(16)

The information processing device according to (15) above, in which, in a case where the different moving body is present, the output control unit further superimposes, on the visual field of the driver, the visual information indicating the presence of the different moving body.

(17)

The information processing device according to (1) above, in which the output control unit superimposes, within the visual field of the driver, the visual information indicating a lane not allowing automatic payment at a tollgate.

(18)

The information processing device according to (1) above, in which the output control unit superimposes the visual information within the visual field of the driver by controlling a head-up display.

(19)

An information processing method including:
superimposing visual information associated with driving assistance at least either within a visual field of a driver, or on a surrounding image indicating surroundings of a moving body and presented to the driver, the visual information being superimposed on the basis of at least any one of a sensing result around the moving body, information acquired from an outside, and information accumulated on the moving body.
   (20)

A moving body including:
a sensing unit that senses surroundings;
a communication unit that communicates with an outside; and
an output unit that superimposes visual information associated with driving assistance at least either within a visual field of a driver, or on a surrounding image presented to the driver, the visual information being superimposed on the basis of at least any one of a sensing result obtained by the sensing unit, information acquired from an outside, and information accumulated inside.

Note that advantages described in the present specification are merely illustrated as examples, and are not the sole examples, and there may be other advantages.

### REFERENCE SIGNS LIST

1: Vehicle
11: Vehicle control system
21: Vehicle control ECU
23: Map information accumulation unit
25: Outside recognition sensor
31: HMI
32: Vehicle control unit
51: Camera
52: Radar
53: LiDAR
54: Ultrasonic sensor
71: Self-position estimation unit
73: Recognition unit
81: Steering control unit
153: Output control unit
154: Output unit
201: Driver's seat
204: Windshield
211: Center display
211LL to 211RR: Display sections
213: Display

1. An information processing device comprising:
an output control unit that superimposes visual information associated with driving assistance at least either within a visual field of a driver, or on a surrounding image indicating surroundings of a moving body and presented to the driver, the visual information being superimposed on a basis of at least any one of a sensing result around the moving body, information acquired from an outside, and information accumulated on the moving body.

2. The information processing device according to claim 1, wherein the output control unit superimposes, within the visual field of the driver, the visual information associated with driving assistance at a roundabout.

3. The information processing device according to claim 2, wherein the output control unit superimposes, within the visual field of the driver, at least either first visual information that is the visual information indicating a first exit through which the moving body leaves from the roundabout, or second visual information that is the visual information associated with prevention of leaving through a second exit different from the first exit.

4. The information processing device according to claim 3, wherein the second visual information is superimposed, within the visual field of the driver, on a road surface extending from the second exit to an outside of the roundabout outside an outer circumference of the roundabout.

5. The information processing device according to claim 2, wherein the output control unit superimposes, within the visual field of the driver, the visual information indicating a traveling direction of the moving body at the roundabout.

6. The information processing device according to claim 5, wherein the visual information is superimposed, within the visual field of the driver, on a position shifted in the traveling direction from a center of the driver.

7. The information processing device according to claim 2, wherein, before entrance into the roundabout, the output control unit superimposes, within the visual field of the driver, the visual information indicating an alert against a different moving body approaching the moving body within the roundabout.

8. The information processing device according to claim 7, wherein the visual information is superimposed, within the visual field of the driver, on a position shifted toward the different moving body from a center of the driver.

9. The information processing device according to claim 1, wherein, in a case of parking of the moving body, the output control unit superimposes, on a back image that is the surrounding image at a back of the moving body, the visual information indicating at least either a position or a shape of an obstacle located at the back of the mobile body.

10. The information processing device according to claim 9, wherein the output control unit changes a display mode of the visual information in a case where the obstacle is present at a position coming into a collision or contact with a back door of the moving body in a case of opening of the back door.

11. The information processing device according to claim 9, wherein the visual information contains at least either a frame surrounding an outer circumference of at least a part of the obstacle, or rectangular cells arranged in a grid shape and superimposed on at least a part of the obstacle.

12. The information processing device according to claim 1, wherein the output control unit superimposes the visual information indicating a space available for parking on the surrounding image, and changes a display mode of the visual information according to a size of the space.

13. The information processing device according to claim 1, wherein the output control unit superimposes the visual information indicating a space available for parking on the surrounding image, and changes a display mode of the visual information in a case where the moving body is parked within the space.

14. The information processing device according to claim 1, wherein the visual information that indicates a track of the moving body predicted on a basis of a state of the moving body during parking is superimposed on the surrounding image.

15. The information processing device according to claim 1, wherein the output control unit superimposes, on the visual field of the driver, the visual information indicating whether or not a safe turn is achievable at an intersection on a basis of presence or absence of a different moving body approaching the intersection on an opposite lane in a case where the moving body turns at the intersection and crosses the opposite lane.

16. The information processing device according to claim 15, wherein, in a case where the different moving body is present, the output control unit further superimposes, on the visual field of the driver, the visual information indicating the presence of the different moving body.

17. The information processing device according to claim 1, wherein the output control unit superimposes, within the visual field of the driver, the visual information indicating a lane not allowing automatic payment at a tollgate.

18. The information processing device according to claim 1, wherein the output control unit superimposes the visual information within the visual field of the driver by controlling a head-up display.

19. An information processing method comprising:
superimposing visual information associated with driving assistance at least either within a visual field of a driver, or on a surrounding image indicating surroundings of a moving body and presented to the driver, the visual information being superimposed on a basis of at least any one of a sensing result around the moving body, information acquired from an outside, and information accumulated on the moving body.

20. A moving body comprising:
a sensing unit that senses surroundings;
a communication unit that communicates with an outside; and
an output unit that superimposes visual information associated with driving assistance at least either within a visual field of a driver, or on a surrounding image presented to the driver, the visual information being superimposed on a basis of at least any one of a sensing result obtained by the sensing unit, information acquired from an outside, and information accumulated inside.
